(19) United States
(12) Patent Application Publication
(10) Pub. No.: US 2007/0225395 A1
(43) Pub. Date: Sep. 27, 2007

(54) Thermally stable cationic photocurable compositions

(76) Inventors: Jean-Pierre Wolf, Maisprach (CH); Stephen Ilg, Giebenach (CH); Jean-Luc Birbaum, Binningen (CH); Eugene Sitzman, Hartsdale, NY (US); David Bramer, Putnam Valley, NY (US); Greg Losapio, Mohegan Lake, NY (US)

Correspondence Address: Patent Department;Ciba Specialty Chemicals Corporation, 540 White Plains Road, P.O. Box 2005, Tarrytown, NY, 10591-9005, US

(21) Appl. No.: 11/803,274

(22) Filed: May 14, 2007

Related U.S. Application Data
(62) Division of application No. 11/040,716, filed on Jan. 21, 2005.
(60) Provisional application No. 60/539,752, filed on Jan. 27, 2004.

(51) Int. Cl. C08F 2/46

(52) U.S. Cl. 522/36; 522/67

(57) ABSTRACT

Disclosed are cationic photocurable compositions with improved shelf life stability. The thermally stable compositions comprise at least one cationically polymerizable compound, for example an epoxy compound, at least one onium salt photoinitiator and at least one compound selected from the group consisting of the organic phosphorus stabilizers and the hindered nitroxyl stabilizers. Also disclosed is a cationic photoinitiator composition comprising at least one onium salt photoinitiator and at least one compound selected from the group consisting of the organic phosphorus stabilizers and the hindered nitroxyl stabilizers.

This application is a divisional of U.S. application Ser. No. 11/040,716, filed Jan. 21, 2005, pending, which claims benefit under 35 USC 119(e) of U.S. provisional application No. 60/539,752, filed Jan. 27, 2004, the contents of which applications are hereby incorporated by reference.

The present invention relates to thermally stable photocurable compositions comprising cationic photoinitiators.

Cationically curable compositions, comprising corresponding initiator compounds are known in the art. Sulfonium salts as photoinitiators are for example described in WO 03/008404 and WO 03/072567, while for example WO 98/02493 and U.S. Pat. No. 6,306,555 disclose iodonium salt photoinitiator compounds.

Cationic systems, or photocurable compositions comprising cationic photoinitiators, are known to have a problem of having insufficient storage stability. In particular, epoxy resins containing iodonium salt cationic photoinitiators exhibit poor shelf life stability (dark stability). Traditionally, Lewis bases are employed to enhance shelf life of these systems, but this approach inhibits the photocure response.

A stabilized cationic photoinitiator system comprising amines is for example suggested in WO 99/35188, while GB 2198736 discloses nitroxyl compounds as stabilizers in radically polymerizable formulations.

Strategies for improving the shelf life stability of photocurable compositions comprising cationic photoinitiators are desired.

Surprisingly, it has been found that certain organic phosphorus stabilizers and hindered nitroxyl stabilizers provide for outstanding shelf life stability of photocurable cationic systems.

Accordingly, disclosed are cationic photocurable compositions with improved shelf life stability comprising
at least one cationically polymerizable compound,
at least one onium salt photoinitiator and
an effective stabilizing amount of at least one compound selected from the group consisting of the organic phosphorus stabilizers and the hindered nitroxyl stabilizers.

The present cationically polymerizable compounds are those which can be cationically polymerized using alkyl- or aryl-containing cations or protons. Typical examples are cyclic ethers, for instance epoxides, as well as vinyl ether and hydroxyl-containing compounds.

The present cationically polymerizable compounds are for example cycloaliphatic epoxy compounds, glycidyl ethers, oxetane compounds, vinyl ethers, acid-crosslinkable melamine resins, acid-crosslinkable hydroxymethylene compounds and acid-crosslinkable alkoxy-methylene compounds.

For instance, the present cationically polymerizable compounds are those described in U.S. Pat. Nos. 6,306,555 and 6,235,807, the disclosures of which are hereby incorporated by reference.

All customary epoxides may be used, such as aromatic, aliphatic or cycloaliphatic epoxy resins. These are compounds having at least one, preferably at least two, epoxy groups in the molecule. Typical examples are the glycidyl ethers and β-methylglycidyl ethers of aliphatic or cycloaliphatic diols or polyols, e.g. those of ethylene glycol, propane-1,2-diol, propane-1,3-diol, butane-1,4-diol, diethylene glycol, polyethylene glycol, polypropylene glycol, glycerol, trimethylolpropane or 1,4-dimethylolcyclohexane, or of 2,2-bis(4-hydroxy-cyclohexyl)propane and N,N-bis(2-hydroxyethyl)aniline; the glycidyl ethers of di- and polyphenols, typically of resorcinol, of 4,4′-dihydroxyphenyl-2,2-propane, of novolaks or of 1,1,2,2-tetrakis(4-hydroxyphenyl)ethane. Illustrative examples are phenyl glycidyl ether, p-tert-butyl glycidyl ether, o-icresyl glycidyl ether, polytetrahydrofuran glycidyl ether, n-butyl glycidyl ether, 2-ethylhexyl glycidyl ether, C_{12/15}alkyl glycidyl ether, cyclohexanedimethanol diglycidyl ether. Other examples are N-glycidyl compounds, typically the glycidyl compounds of ethylene urea, 1,3-propylene urea or 5-dimethylhydantoin or of 4,4′-methylene-5,5′- tetramethyldihydantoin, or e.g. triglycidyl isocyanurate.

Other technically important glycidyl compounds are the glycidyl esters of carboxylic acid, preferably di- and polycarboxylic acids. Typical examples are the glycidyl esters of succinic acid, adipic acid, azelaic acid, sebacic acid, phthalic acid, terephthalic acid, tetra- and hexahydrophthalic acid, isophthalic acid or trimellitic acid, or of dimerised fatty acids.

Illustrative examples of polyepoxides which are not glycidyl compounds are the epoxides of vinyl cyclohexane and dicyclopentadiene, 3-(3′, 4′-epoxicyclohexyl)-8,9-epoxy-2,4-dioxaspiro-[5.5]undecane, of the 3′, 4′-epoxycyclohexylmethyl ester of 3,4-epoxycyclohexane carboxylic acid, butadiene diepoxide or isoprene diepoxide, epoxidised linolic acid derivatives or epoxidised polybutadiene.

Other suitable epoxy resins are, for example, epoxy resins of bisphenol A and bisphenol F, e.g. Araldit® GY 250 (A), Araldit® GY 282 (F), Araldit® GY 285 (F) (supplied by Ciba Specialty Chemicals).

Further suitable cationically polymerizable components are also be found, inter alia, in U.S. Pat. Nos. 4,299,938 and 4,339,567, the disclosures of which are hereby incorporated by reference.

Of the group of the aliphatic epoxides, the monofunctional α-olefin epoxides having an unbranched chain consisting of 10, 12, 14 and 16 carbon atoms are particularly suitable.

As a large number of different epoxy resins is commercially available today, it is possible to substantially vary the properties of the binder. Another possibility for variation consists in using mixtures of different epoxy resins and also in the addition of flexibilizers and reactive thinners.

To facilitate their application, the epoxy resins may be diluted with a solvent, for example when the application is carried out by spraying. Preferably, however, the epoxy resin is used in solvent-free state. Resins that are viscous to solid at room temperature can be applied hot.

All customary vinyl ethers may be used, such as aromatic, aliphatic or cycloaliphatic vinyl ethers. These are compounds having at least one, preferably at least two, vinyl ether groups in the molecule. Typical examples of vinyl ethers suitable according to this invention are triethylene glycol divinyl ether, 1,4-cyclohexanedimethanol divinyl ether, 4-hydroxybutyl vinyl ether, the propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butyl vinyl ether, butanediol-1,4-divinyl ether, hexanediol divinyl ether, diethylene glycol divinyl ether, triethylene glycol methyl vinyl ether, tetraethylene glycol divinyl ether, pluriol-E-200-divinyl ether, polytetrahydrofuran-290-divinyl ether, trimethylolpropane trivinyl ether, dipropylene glycol divinyl ether, octadecyl vinyl ether, methyl (4-cyclohexylmethyleneoxyethene)glutarate and (4-butyloxyethene)isophthalate.

Illustrative examples of hydroxyl-containing compounds are polyester polyols, such as polycaprolactones or polyester adipate polyols, glycols and polyether polyols, castor oil, hydroxyfunctional vinyl and acrylic resins, cellulose esters, such as cellulose acetate butyrate, and phenoxy resins.

Additional cationically curable formulations may be found, inter alia, in U.S. application 19830464571 (EP119425), the disclosure of which is hereby incorporated by reference.

For instance, the present cationically polymerizable compounds are cycloaliphatic epoxides or epoxides based on bisphenol A. For example, the cationically polymerizable compounds are diglycidyl ethers of bisphenol A, bisphenol F or bisphenol S.

The term “at least” is meant to define one or more than one, for example one or two or three, preferably one or two.

The term “optionally substituted” means, that the radical to which it refers is either unsubstituted or substituted.

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The onium salt photoinitiators are for example iodonium salt compounds as disclosed in U.S. Pat. Nos. 6,306,555 and 6,235,807, the disclosures of which are hereby incorporated by reference.

For example, the iodonium salt photoinitiators are of the formula
(R₁—I—R₂)⁺.(A⁻) (I),
where
R₁ and R₂ are each independently of the other phenyl which is unsubstituted or is substituted by C₁-C₂₄alkyl, C₁-C₂₄alkoxy, —NO₂, —Cl, —Br, —CN, —COOR₃, —SR₃ or 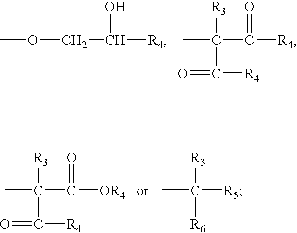
or R₁ and R₂ together are a radical 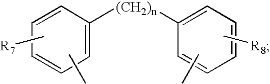
n is a number from 0 to 6;
R₃ is hydrogen or C₁-C₁₂alkyl;
R4 is C₁-C₁₈alkyl or phenyl;
R₅ and R₆ are —CN, or R₅ is —NO₂, and R₆ is phenyl;
R₇ and R₈ are each independently of the other C₁-C₂₄alkyl, C₁-C₂₄alkoxy, —NO₂, —Cl, —Br, —CN, —COOR₃, or —SR₃; and
A⁻is an anion selected from the group consisting of (BF₄)⁻, (SbF₆)⁻, (PF₆)⁻, (B(C₆F₅))₄⁻, C₁-C₂₀alkylsulfonate, C₂-C₂₀haloalkylsulfonate, unsubstituted C₆-C₁₀arylsulfonate, camphor-sulfonate, C₁-C₂₀-perfluoroalkylsulfonylmethide, C₁-C₂₀-perfluoroalkylsulfonylimide, and C₆-C₁₀arylsulfonate substituted by halogen, —NO₂, C₁-C₁₂alkyl, C₁-C₁₂halo-alkyl, C₁-C₁₂alkoxy or by COOR₁.

As the onium salt in the presently claimed compositions in particular iodonium salts with anions selected from the group consisiting of (BF₄)⁻, (SbF₆)⁻, (PF₆)⁻, (B(C₆F₅))₄⁻, C₁-C₂₀alkylsulfonate, C₂-C₂₀haloalkylsulfonate, unsubstituted C₆-C₁₀arylsulfonate, camphor-sulfonate, C₁-C₂₀-perfluoroalkylsulfonylmethide, C₁-C₂₀-perfluoroalkylsulfonylimide, and
C₆-C₁₀arylsulfonate substituted by halogen, —NO₂, C₁-C₁₂alkyl, C₁-C₁₂halo-alkyl, C₁-C₁₂alkoxy or by COOR₁ are used.

Alkylsulfonate is RSO₃⁻ wherein R is linear or branched alkyl as described above. Examples thereof include methylsulfonate, ethylsulfonate, propylsulfonate, pentylsulfonate and hexylsulfonate.

Haloalkylsulfonate is RSO₃⁻ wherein R is halo-substituted C₂-C₂₀alkyl, C₂-C₁₀-, C₂-C₈- or C₄-C₈-alkyl. Examples thereof include C₂F₅SO₃⁻, C₄F₉SO₃⁻ and C₈ F₁₇SO₃⁻.

Unsubstituted C₆-C₁₀arylsulfonate is RSO₃⁻ wherein R is C₆-C₁₀aryl, e.g. phenyl or naphthyl.

Alkyl-substituted arylsulfonates are, for example, toluenesulfonate, 2,4,6-trimethylbenzene-sulfonate, 2,4,6-tris(isopropyl)benzenesulfonate, 4-tert-butylbenzenesulfonate and 4-dodecylbenzenesulfonate.

Halo-substituted arylsulfonates are, for example, 4-chlorobenzenesulfonate, 4-fluoro-benzenesulfonate, 2,4,6-trifluorobenzenesulfonate and pentafluorobenzenesulfonate.

Camphorsulfonate is

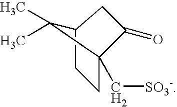

Perfluoroalkylsulfonylmethide is 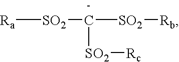
perfluoroalkylsulfonylimide is Rₐ—SO₂— N̅—SO₂—R_{b}, wherein Rₐ, R_{b} and R_{c} independently of one another are C₁-C₂₀perfluoroalkyl which is unsubstituted or is substituted by N(R_{d})(Rₑ), or Rₐ, R_{b} and R_{c} are phenyl substituted by CF₃; or Rₐ and R_{b} together are C₁-C₆-perfluoroalkylene, which optionally is interrupted by —O—; R_{d} and Rₑ independently of one another are C₁-C₁₂alkyl or R_{d} and Rₑ together are C₁-C₆perfluorolkylene, which optionally is interrupted by O or N(C₁-C₁₂-alkyl).

Perfluoroalkyl is alkyl which is fully substituted by fluoro, i.e. the hydrogen atoms are replaced by fluoro. The same applies for the perfluoroalkylene. Examples of such anions are (C₂F₅SO₂)₂N⁻, (C₄F₉SO₂)₂N⁻, (C₈F₁₇SO₂) ₃C⁻, (CF₃SO₂)₃⁻, (CF₃SO₂)₂N⁻, (C₄F₉SO₂)₃C⁻, (CF₃SO₂)₂(C₄F₉SO₂)C⁻, (CF₃SO₂)(C₄F₉SO₂)N⁻, [(3,5-bis(CF₃)(C₆H₃)SO₂]₂N⁻, 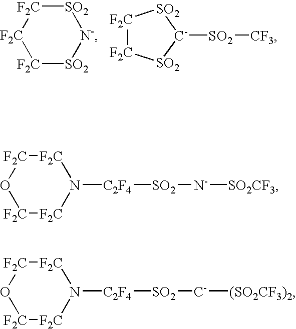
C₆F₅SO₂C⁻(SO₂CF₃)₂, C₆F₅SO₂N⁻SO₂CF₃.

Such anions are known the person skilled in the art. The anions as well as their preparation are described e.g. in U.S. Pat. No. 5,554,664, hereby incorporated by reference.

Substituted phenyl is substituted at the phenyl ring one to five times, for example one, two or three times, in particular one or two times, preferably once.

Compounds where R₁ and R₂ are identical are also interesting.

Other interesting iodonium comounds are those where R₁ and R₂ are each independently of the other phenyl which is unsubstituted or substituted by C₁-C₂₄alkyl, C₁-C₂₄alkoxy, —NO₂, —Cl, —Br, —CN, —COOR₃ or —SR₃.

For example, the present iodonium comounds are those where R₁ and R₂ are C₁-C₂₄alkyl- or C₁-C₂₄alkoxy-substituted phenyl.

The anions are for example SbF₆⁻ or PF₆⁻ or (B(C₆F₅))₄⁻ anions.

Illustrative examples of iodonium salt compounds are bis(4-hexylphenyl)iodonium hexafluoroantimonate; bis(4-hexylphenyl)iodonium hexafluorophosphate; (4-hexylphenyl)phenyliodonium hexafluoroantimonate; (4-hexylphenyl)phenyliodonium hexafluorophosphate; bis(4-octylphenyl)iodonium hexafluoroantimonate; (4-sec-butylphenyl)-(4′-methylphenyl)iodonium hexafluorophosphate; (4-iso-proylphenyl)-(4′-methylphenyl)iodonium hexafluorophosphate; [4-(2-hydroxytetradecyloxy)phenyl]phenyliodonium hexafluoroantimonate; [4-(2-hydroxydodecyloxy)phenyl]phenyliodonium hexafluoroantimonate; bis(4-octylphenyl)iodonium hexafluorophosphate; (4-octylphenyl)phenyliodonium hexafluoroantimonate; (4-octylphenyl)phenyliodonium hexafluorophosphate; bis(4-decylphenyl)iodonium hexafluoroantimonate; bis(4-decylphenyl)iodonium hexafluorophosphate; (4-decylphenyl)phenyliodonium hexafluoroantimonate; (4-decylphenyl)phenyliodonium hexafluorophosphate; (4-octyloxyphenyl)phenyliodonium hexafluoroantimonate; (4-octyloxyphenyl)phenyliodonium hexafluorophosphate; (2-hydroxydodecyloxyphenyl)phenyliodonium hexafluoroantimonate; (2-hydroxydodecyloxyphenyl)phenyliodonium hexafluorophosphate; bis(4-hexylphenyl)iodonium tetrafluoroborate; (4-hexylphenyl)phenyliodonium tetrafluoroborate; bis(4-octylphenyl)iodonium tetrafluoroborate; (4-octylphenyl)phenyl-iodonium tetrafluoroborate; bis(4-decylphenyl)iodonium tetrafluoroborate; bis(4-(mixed C₈-C₁₄alkyl)phenyl)iodonium hexafluoroantimonate; (4-decylphenyl)phenyliodonium tetrafluoroborate; (4-octyloxyphenyl)phenyliodonium tetrafluoroborate; (2-hydroxydodecyloxyphenyl)phenyliodonium tetrafluoroborate; biphenylene iodonium tetrafluoroborate; biphenylene iodonium hexafluorophosphate; biphenylene iodonium hexafluoroantimonate.

Other illustrative examples of iodonium photoinitiators are 4-isobutylphenyl-4′-methylphenyl-iodonium hexafluoro-phosphate; 4-isobutylphenyl-4′-methylphenyliodonium pentafluoroethyl-sulfonate; 4-isobutylphenyl-4′-methylphenyliodonium tresylate; 4-isobutylphenyl-4′-methyl-phenyliodonium nonaflate; 4-isobutylphenyl-4′-methylphenyliodonium tosylate; 4-isobutyl-phenyl-4′-methyl-phenyliodonium 4-methoxyphenylsulfonate; 4-isobutylphenyl-4′-methyl-phenyliodonium 4-chlorophenylsulfonate; 4-isobutylphenyl-4′-methylphenyliodonium 4-fluorophenylsulfonate; 4-isobutylphenyl-4′-methylphenyliodonium 2,4,6-trimethylphenylsulfonate; 4-isobutylphenyl-4′-methylphenyliodonium 2,4,6-(tri-isopropyl)-phenylsulfonate; 4-isobutylphenyl-4′-methyl-phenyliodonium 4-dodecylphenylsulfonate; 4-isobutylphenyl-4′-methylphenyliodonium camphor-10-sulfonate; 4-isobutylphenyl-4′-methylphenyliodonium tetrakis(pentafluorophenyl)-borate; 4-isopropylphenyl-4′-methylphenyliodonium tetrakis(pentafluorophenyl)-borate; 4-(2-methylbut-2-yl)phenyl-4′-methylphenyliodonium hexafluorophosphate; 4-(2-methylbut-2-yl)phenyl-4′-methylphenyliodnium pentafluoroethylsulfonate; 4-(2-methylbut-2-yl)phenyl-4′-methylphenyliodonium tetrakis(pentafluorophenyl)borate; 4-(2-methylbut-2-yl)phenyl-4′-methylphenyliodonium hexafluorophosphate; 4-(2-methylbut-2-yl)phenyl-4′-methylphenyliodonium pentafluoroethylsulfonate; 4-(2-methylbut-2-yl)phenyl-4′-methyl-phenyliodonium nonaflate; 4-(2-methylbut-2-yl)phenyl-4′-methylphenyliodonium 4-trifluoro-methylphenylsulfonate; 4-(2-methylbut-2-yl)phenyl4′-methylphenyliodonium tosylate; 4-(2-methylbut-2-yl)phenyl-4′-methylphenyliodonium camphor-10-sulfonate; 4-cyclohexyl-4′-methylphenyliodonium hexafluorophosphate; 4-cyclohexyl-4′-methylphenyliodonium penta-fluoroethylsulfonate; 4-cyclohexyl-4′-methylphenyliodonium camphor-10-sulfonate; 4-cyclohexyl-4′-methylphenyl-iodonium tetrakis(penta-fluorophenyl)borate; 4-cyclohexyl-4′-methyl-phenyliodonium tosylate; 4-tert-butylphenyl-4′-methylphenyliodonium hexafluorophosphate; 4-tert-butylphenyl-4′-methylphenyliodonium pentafluoroethylsulfonate; 4-tert-butylphenyl-4′-methylphenyliodonium camphor-10-sulfonate; 4-tert-butylphenyl-4′-methylphenyliodonium tetrakis(pentafluorophenyl)borate; 4-tert-butylphenyl-4′-methylphenyliodonium 4-chloro-phenylsulfonate; 4-tert-butylphenyl-4′-methylphenyliodonium 4-fluorophenylsulfonate; 4-tert-butylphenyl-4′-methylphenyliodonium 4-methoxyphenylsulf-o-nate; 4-tert-butylphenyl-4′-methylphenyliodonium hexafluorophosphate; 4-isobutylphenyl-4′-methylphenyliodonium nonafluorobutylsulfonate; 4-cyclohexyl-4′-methylphenyliodonium hexafluoroantimonate; 4-(2-methylbut-2-yl)phenyl-4′-methylphenyliodonium nonafluorobutyl-sulfonate; 4-isobutyl-phenyl-2′-methylphenyliodonium hexafluorophosphate; 4-isobutylphenyl-4′-ethylphenyl-iodonium hexafluorophosphate; and 4-(branched dodecyl)-4-methylphenyliodonium hexafluorophosphate.

The preparation of the iodonium photoinitiator compounds is known to the skilled person and is described in the literature. The compounds may be found, inter alia, in U.S. Pat. Nos. 5,468,902, 4,399,071, 4,329,300 and 4,151,175, the disclosures of which are hereby incorporated by reference.

The onium salt photoinitiators suitable in the context of the present invention further are for example sulfonium salt compounds as disclosed for example in WO 03/008404 or WO 03/072567, the disclosures of which are hereby incorporated by reference.

Examples are compounds of the formula
(III) or (IV) 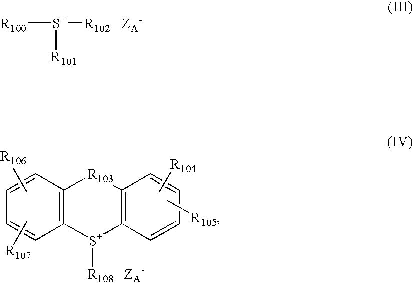
wherein
R₁₀₀, R₁₀₁ and R₁₀₂ are each independently of the others unsubstituted phenyl, or phenyl substituted by —S-phenyl or by 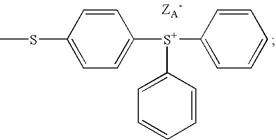
R₁₀₃ is a direct bond, S, O, CH₂, (CH₂)₂, CO or NR₁₀₉;
R₁₀₄, R₁₀₅, R₁₀₆ and R₁₀₇ independently of one another are H, C₁-C₂₀alkyl, C₃-C₈cycloalkyl, C₁-C₂₀alkoxy, C₂-C₂₀alkenyl, CN, OH, halogen, C₁-C₆alkylthio, phenyl, naphthyl, phenyl-C₁-C₇alkyl, naphtyl-C₁-C₃alkyl, phenoxy, naphthyloxy, phenyl-C₁-C₇alkyloxy, naphtyl-C₁-C₃alkyloxy, phenyl-C₂-C₆alkenyl, naphthyl-C₂-C₄alkenyl, S-phenyl, (CO)R₁₀₉, O(CO)R₁₀₉, (CO)OR₁₀₉, SO₂R₁₀₉, OSO₂R₁₀₉;
R₁₀₈ is C₁-C₂₀alkyl, C₁-C₂₀hydroxyalkyl, 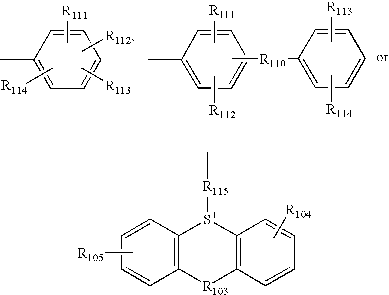
R₁₀₉ is H, C₁-C₁₂alkyl, C₁-C₁₂hydroxyalkyl, phenyl, naphthyl or biphenylyl;
R₁₁₀ is a direct bond, S, O or CH₂;
R₁₁₁, R₁₁₂, R₁₁₃ and R₁₁₄ independently of one another have one of the meanings as given for R₁₀₄; or R₁₁₁ and R₁₁₃ are joined to form a fused ring system with the benzene rings to which they are attached; 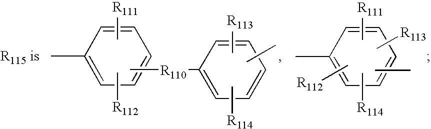
and
Z_{A} is an anion, especially PF₆, SbF₆, AsF₆, BF₄, (C₆F₅)₄B, Cl, Br, HSO₄, CF₃—SO₃, F—SO₃, 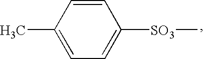
CH₃—SO₃, CIO₄, PO₄, NO₃, SO₄, CH₃—SO₄, or

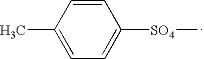

Specific sulfonium salts are obtainable, for example, under the trade names ®Cyracure UVI-6990, ®Cyracure UVI-6974 (Union Carbide), ®Degacure KI 85 (Degussa), SP-55, SP-150, SP-170 (Asahi Denka), GE UVE 1014 (General Electric), SarCate® KI-85 (=triarylsulfonium hexafluorophosphate; Sartomer), SarCat® CD 1010 (=mixed triarylsulfonium hexafluoroantimonate; Sartomer); SarCate® CD 1011(=mixed triarylsulfonium hexafluorophosphate; Sartomer).

In the compositions of this invention, the onium salt photoinitiators are present from about 0.05% to about 15% by weight, based on the weight of the composition. For instance, the onium salt photoinitiators are present from about 0.1% to about 10%, or from about 0.5% to about 5% by weight, based on the weight of the composition. For instance, the present onium salt compounds are present from about 0.1% to about 5%, or from about 0.1% to about 15%, or from about 0.5% to about 10% or from about 0.5% to about 15%, based on the weight of the composition.

The compositions according to the invention may comprise mixtures of one or more different onium salts, e.g. mixtures of one or more different iodonium salts, mixtures of one or more different sulphonium salts or mixtures of one or more different iodonium and sulphonium salts.

The present organic phosphorus stabilizers are as disclosed for example in U.S. Pat. No. 6,444,733, the disclosure of which is hereby incorporated by reference. Organic phosphorus stabilizers are known and many are commercially available. For instance, the present organic phosphorus stabilizers are of the formula (1), (2), (3), (4), (5), (6) or (7), 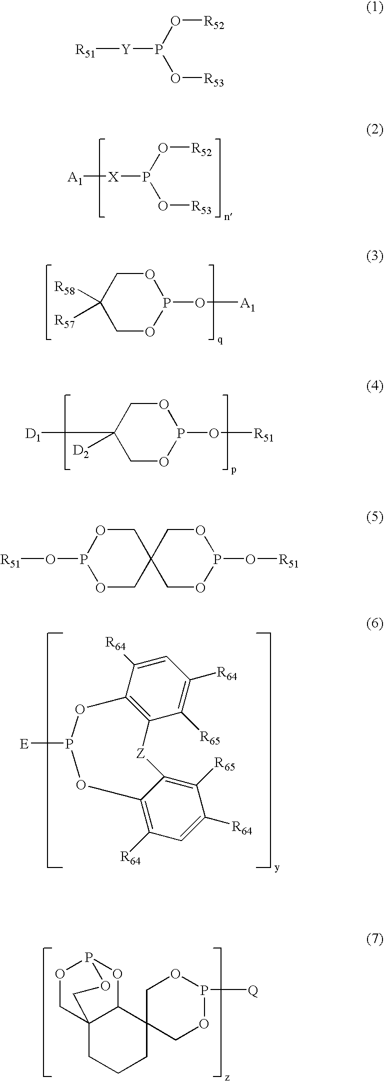
in which the indices are integral and
n′ is 2,3 or 4; p is 1 or 2; q is 2 or 3; r is 4 to 12; y is 1, 2 or 3; and z is 1 to 6;
A₁, if n is 2, is C₂-C₁₈ alkylene; C₂-C₁₂ alkylene interrupted by oxygen, sulfur or —NR₅₄—; a radical of the formula 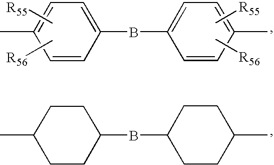
or phenylene;
A₁, if n is 3, is a radical of the formula —CᵣH₂ᵣ₋₁—;
A₁, if n is 4, is 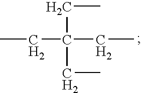
A₂ is as defined for A₁ if n is 2;
B is a direct bond, —CH₂—, —CHR₅₄—, —CR₅₁R₅₄—, sulfur, C₅-C₇cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂, if p is 1, is C₁-C₄ alkyl;
E, if y is 1, is C₁-C₁₈ alkyl, —OR₅₁ or halogen;
E, if y is 2, is —O-A₂-O—,
E, if y is 3, is a radical of the formula R₅₄C(CH₂O—)₃ or N(CH₂CH₂O—)₃;
Q is the radical of an at least z-valent alcohol or phenol, this radical being attached via the oxygen atom to the phosphorus atom;
R₅₁, R₅₂ and R₅₃ independently of one another are C₁-C18 alkyl which is unsubstituted or substituted by halogen, —COOR₅₄, —CN or —CONR₅₄R₅₄; C₂-C₁₈ alkyl interrupted by oxygen, sulfur or —NR₅₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to
18 carbon atoms or by C₇-C₉ phenylalkyl; or a radical of the formula 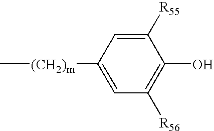
in which m is an integer from the range 3 to 6;
R₅₄ is hydrogen, C₁-C₁₈ alkyl, C₅-C₁₂ cycloalkyl or C₇-C₉ phenylalkyl,
R₅₅ and R₅₆ independently of one another are hydrogen, C₁-C₈ alkyl or C₅-C₆ cycloalkyl,
R₅₇ and R₅₈, if q is 2, independently of one another are C₁-C₄ alkyl or together are a 2,3-dehydropentamethylene radical; and
R₅₇ and R₅₈, if q is 3, are methyl;
R₆₄ is hydrogen, C₁-C₉ alkyl or cyclohexyl,
R₆₅ is hydrogen or methyl and, if two or more radicals R₆₄ and R₆₅ are present, these radicals are identical or different,
X and Y are each a direct bond or oxygen,
Z is a direct bond, methylene, —C(R₆₆)₂— or sulfur, and
R₆₆ is C₁-C₈ alkyl.

The organic phosphorus stabilizers are for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite(D), bis(2,6-di-tert-butyl-4-methylphenyl) pentaerythritol diphosphite (E), bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis (2,4-di-tert-butylphenyl) 4,4′-biphenylene-diphosphonite (H), 6-isooctyloxy-2,4,8,10-tetra-tert-butyl-dibenzo[d,f][1,3,2]dioxaphosphepin (C), 6-fluoro-2,4,8,10-tetra-tert-butyl-12-methyl-dibenzo[d,g][1,3,2]dioxaphosphocin (A), bis(2,4-di-tert-butyl-6-methylphenyl)methyl phosphite or bis(2,4-di-tert-butyl-6-methylphenyl) ethyl phosphite (G).

The organic phosphorus stabilizers are for example tris(2,4-di-tert-butylphenyl) phosphite, tris(nonylphenyl) phosphite,

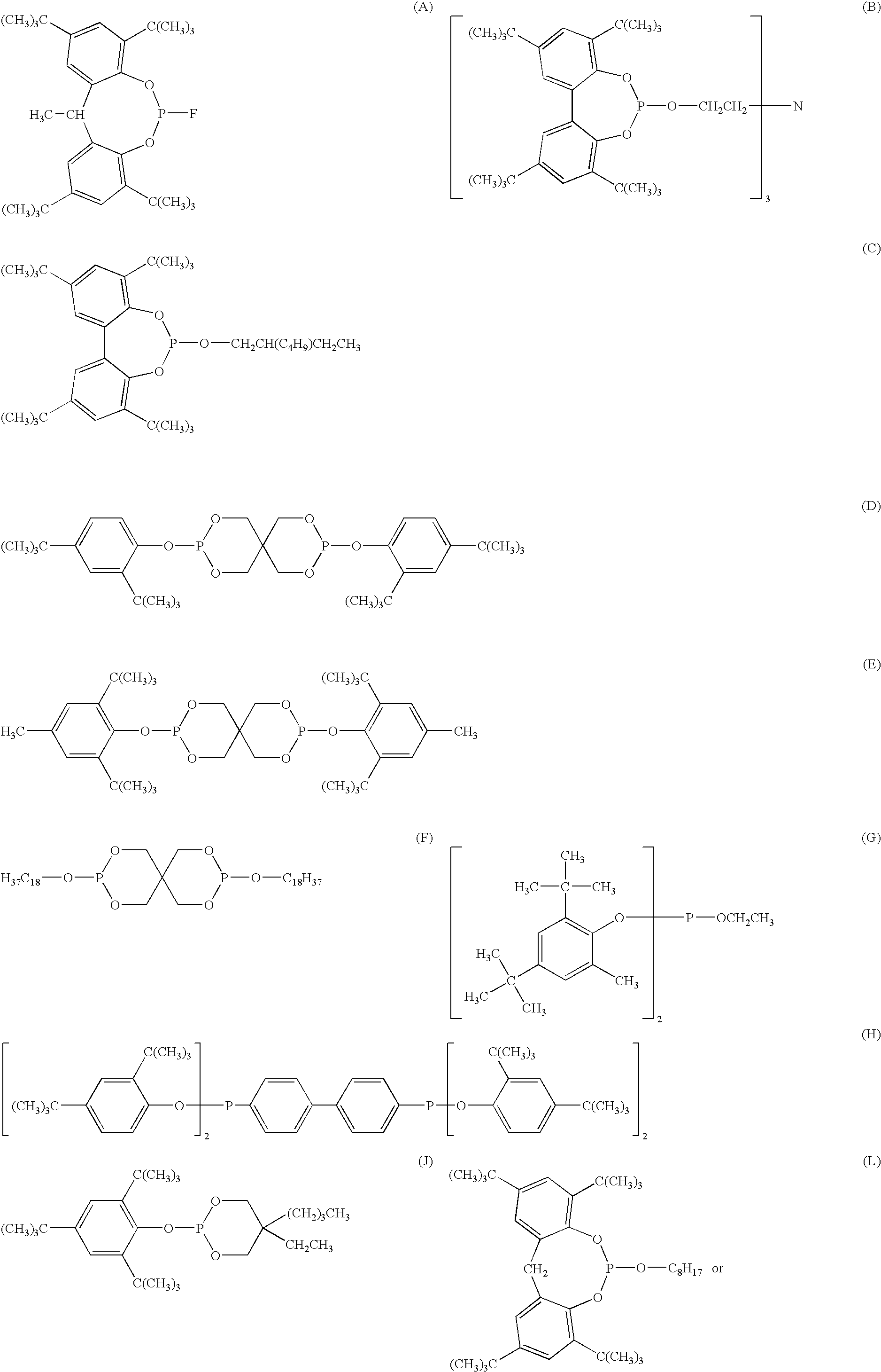

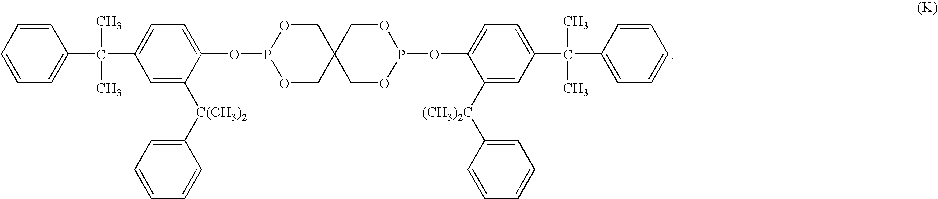

The organic phosphorus stabilizers are for example tris(2,4-di-tert-butylphenyl) phosphite, bis(2,4-di-tert-butyl-6-methylphenyl) ethyl phosphite (G), bis(2,4-di-tert-butylphenyl) pentaerythritol diphosphite (D), tetrakis(2,4-di-tert-butylphenyl)4,4′-biphenylene-diphosphonite (H), 2,2′, 2″-nitrilo[triethyltris(3,3′5,5′-tetra-tert-butyl-1,1′-biphenyl-2,2′-diyl)phosphite] (B), compound (J), compound (K) or compound (L).

Hindered nitroxyl stabilizers, or hindered nitroxides, are well known in the art and are disclosed for example in U.S. Pat. Nos. 6,337,426, 5,254,760, the relevant disclosures of which are hereby incorporated by reference.

For example, the present hindered nitroxyl stabilizers are of the formula 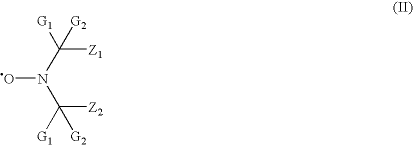
wherein G₁ and G₂ are independently alkyl of 1 to 4 carbon atoms or are together pentamethylene; and
Z₁ and Z₂ are each methyl or Z₁ and Z₂ together form a linking moiety which may or may not contain heteroatoms or carbonyl groups and which additionally may be substituted by hydroxy, cyanohydrin, amino, alkoxy, amido, ketal, carboxy, hydantoin, carbamate, or a urethane group.

For example, the present hindered nitroxyl stabilizers are of the formula 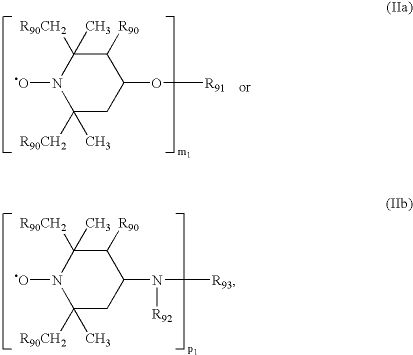
R₉₀ is hydrogen or methyl,
m₁ is 1 to 4,
when m₁ is 1,
R₉₁ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, a monovalent acyl radical of an aliphatic, cycloaliphatic or aromatic carboxylic acid, or a carbamic acid, for example an acyl radical of an aliphatic carboxylic acid having 2-18 carbon atoms, of a cycloaliphatic carboxylic acid having 5-12 carbon atoms or of an aromatic carboxylic acid having 7-15 carbon atoms, or 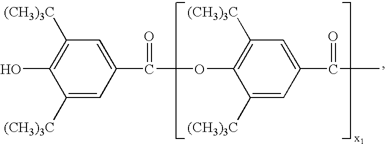
wherein x₁ is 0 or 1, 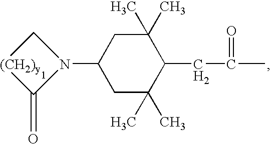
wherein y₁ is 2-4;
when m₁ is 2, R₉₁ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 carbon atoms, of a cycloaliphatic or aromatic dicarboxylic acid having 8-14 carbon atoms, or of an aliphatic, cycloaliphatic or aromatic dicarbamic acid having 8-14 carbon atoms; or R₉₁ is 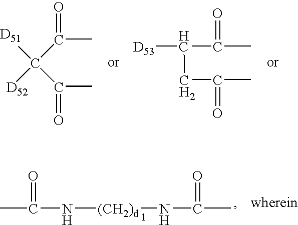
D₅₁ and D₅₂ are independently hydrogen, an alkyl radical containing up to 8 carbon atoms, an aryl or aralkyl radical including 3,5-di-t-butyl-4-hydroxybenzyl radical;
D₅₃ is hydrogen, or an alkyl or alkenyl radical containing up to 18 carbon atoms, and d₁ is 0-20;
when m₁ is 3, R₉₁ is a trivalent acyl radical of an aliphatic, unsaturated aliphatic, cycloaliphatic, or aromatic tricarboxylic acid;
when m₁ is 4, R₉₁ is a tetravalent acyl radical of a saturated or unsaturated aliphatic or aromatic tetracarboxylic acid including 1,2,3,4-butanetetracarboxylic acid, 1,2,3,4-but-2-enetetracarboxylic, and 1,2,3,5- and 1,2,4,5-pentanetetracarboxylic acid;
p₁ is 1, 2 or 3;
R₉₂ is hydrogen, C₁-C₁₂alkyl, C₅-C₇cycloalkyl, C₇-C₉aralkyl, C₂-C₁₈alkanoyl, C₃-C₃-C₅alkenoyl or benzoyl;
when p₁ is 1, R₉₃ is hydrogen, C₁-C₁₈alkyl, C₅-C₇cycloalkyl, C₂-C₈alkenyl, unsubstituted or substituted by a cyano, carbonyl or carbamide group, aryl, aralkyl, or it is glycidyl, a group of the formula —CH₂—CH(OH)—Zₐ or of the formula —CO—Zₐ or —CONH—Zₐ wherein Zₐ is hydrogen, methyl or phenyl; or a group of the formula 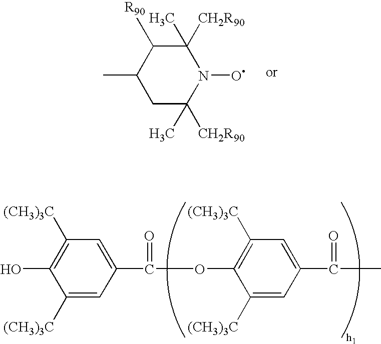
where h₁ is 0 or 1
R₉₂ and R₉₃ together, when p is 1, can be alkylene of 4 to 6 carbon atoms or 2-oxo-polyalkylene the cyclic acyl radical of an aliphatic or aromatic 1,2- or 1,3-dicarboxylic acid,
when p₁ is 2, R₉₃ is a direct bond or is C₁-C₁₂alkylene, C₆-C₁₂arylene, xylylene, a —CH₂CH(OH)—CH₂— group or a group —CH₂—CH(OH)—CH₂—O—X—O—CH₂—CH(OH)—CH₂— wherein X is C₂-C₁₀alkylene, C₆-C₁₅arylene or C₆-C₁₂cycloalkylene; or, provided that R₉₂ is not alkanoyl, alkenoyl or benzoyl, R₉₃ can also be a divalent acyl radical of an aliphatic, cycloaliphatic or aromatic dicarboxylic acid or dicarbamic acid, or can be the group —CO—; or R₉₃ is 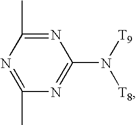
where T₈ and T₉ are independently hydrogen, alkyl of 1 to 18 carbon atoms, or T₈ and T₉ together are alkylene of 4 to 6 carbon atoms or 3-oxapentamethylene, for instance T₈ and T₉ together are 3-oxapentamethylene; and when p₁ is 3, R₉₃ is 2,4,6-triazinyl.

Typical nitroxyl stabilizers include bis(1-oxyl-2,2,6,6-tetramethylpiperidin-4-yl) sebacate, 4-hydroxy-1-oxyl-2,2,6,6-tetramethylpiperidine, 4-ethoxy-1-oxyl-2,2,6,6-tetramethylpiperidine, 4-propoxy-1-oxyl-2,2,6,6-tetramethylpiperidine, 4-acetamido-1-oxyl-2,2,6,6-tetramethylpiperldine, 1-oxyl-2,2,6,6-tetramethylpiperidine, 1-oxyl-2,2,6,6-tetramethylpiperidin-4-one, 1-oxyl-2,2,6,6-tetramethylpiperidin-4-yl acetate, 1-oxyl-2,2,6,6-tetramethylpiperidin-4-yl 2-ethylhexanoate, 1-oxyl-2,2,6,6-tetramethylpiperidin-4-yl stearate, 1-oxyl-2,2,6,6-tetramethylpiperidin-4-yl benzoate, 1 -oxyl-2,2,6,6-tetramethylpiperidin-4-yl 4-t-butyl-benzoate, bis(1-oxyl-2,2,6,6-tetramethylpiperidin-4-yl) succinate, bis(1-oxyl-2,2,6,6-tetramethylpiperidin-4-yl) adipate, bis(1-oxyl-2,2,6,6-tetramethylpiperidin-4-yl) n-butylmalonate, bis(1-oxyl-2,2,6,6-tetramethylpiperidin-4-yl) phthalate, bis(1-oxyl-2,2,6,6-tetramethylpiperidin-4-yl) isophthalate, bis(1-oxyl-2,2,6,6-tetramethylpiperidin-4-yl) terephthalate, bis(1-oxyl-2,2,6,6-tetramethylpiperidin-4-yl) hexahydroterephthalate, N,N′-bis(1 -oxyl-2,2,6,6-tetramethylpiperidin-4-yl)adipamide, N-(1-oxyl-2,2,6,6-tetramethylpiperidin-4-yl)caprolactam, N-(1-oxyl-2,2,6,6-tetramethylpiperidin-4-yl)dodecylsuccinimide, 2,4,6-tris-[N-butyl-N-(1-oxyl-2,2,6,6-tetramethylpiperidin-4-yl)]-s-triazine, 4,4′-ethylenebis(1-oxyl-2,2,6,6-tetramethylpiperazin-3-one), 2-oxyl-1,1,3,3-tetramethyl-2-isobenzazole, 1-oxyl-2,2,5,5-tetramethylpyrrolidine, and N, N-bis-(1,1,3,3-tetramethylbutyl)nitroxide.

Nitroxyl stabilizers are for example bis(1-oxyl-2,2,6,6-tetramethylpiperidin-4-yl) sebacate, 4-hydroxy-1-oxyl-2,2,6,6-tetramethylpiperidine, 4-ethoxy-1-oxyl-2,2,6,6-tetramethylpiperidine, 4-propoxy-1-oxyl-2,2,6,6-tetramethylpiperidine, 4-acetamido-1-oxyl-2,2,6,6-tetramethylpiperidine, 1-oxyl-2,2,6,6-tetramethylpiperidine, and 1-oxyl-2,2,6,6-tetramethylpiperidin-4-one.

A specific embodiment is where the nitroxyl stabilizers are bis(1-oxyl-2,2,6,6-tetramethylpiperidin-4-yl) sebacate or 4-hydroxy-1-oxyl-2,2,6,6-tetramethylpiperidine.

Alkenylene is unsaturated alkylene. Alkenyl is unsaturated version of alkyl.

Alkanoyl is a branched or unbranched radical, for example formyl, acetyl, propionyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, icosanoyl or docosanoyl. Alkenoyl is unsaturated alkanoyl.

Arylene is for instance phenylene or naphthylene each unsubstituted or substituted by C₁-C₄alkyl is, for example, 1,2-, 1,3- or 1,4-phenylene or 1,2-, 1,3-, 1,4-, 1,6-, 1,7, 2,6- or 2,7-naphthylene. For instance 1,4-phenylene.

Cycloalkylene is for example substituted by from 1 to 3, especially 1 or 2, branched or unbranched C₁-C₄alkyl groups, and is, for example, cyclopentylene, methylcyclopentylene, dimethylcyclopentylene, cyclohexylene, methylcyclohexylene, dimethylcyclohexylene, trimethylcyclohexylene, tert-butylcyclohexylene, cycloheptylene or cyclooctylene. Preference is given to cyclohexylene and tert-butylcyclohexylene.

Alkyl is linear or branched and is typically C₁-C₁₂alkyl, C₁-C₈alkyl, C₁-C₆alkyl or C₁-C₄-alkyl. Typical examples are methyl, ethyl, propyl, isopropyl, n-butyl, sec-butyl, isobutyl, tert-butyl, pentyl, hexyl, heptyl, 2,4,4-trimethylpentyl, 2-ethylhexyl, octyl, nonyl, decyl, undecyl, dodecyl, tetradecyl, pentadecyl, hexadecyl, heptadecyl, octadecyl, nonadecyl or icosyl.

Alkoxy is linear or branched radicals, typically methoxy, ethoxy, propoxy, isopropoxy, n-butyloxy, sec-butyloxy, isobutyloxy, tert-butyloxy, pentyloxy, hexyloxy, heptyloxy, 2,4,4-trimethylpentyloxy, 2-ethylhexyloxy, octyloxy, nonyloxy, decyloxy, dodecyloxy or icosyloxy, in particular methoxy, ethoxy, propoxy, isopropoxy, n-butyloxy, sec-butyloxy, isobutyloxy, tert-butyloxy, octyloxy, preferably methoxy and octyloxy.

Halogen is fluorine, chlorine, bromine or iodine, especially chlorine or fluorine, preferably fluorine.

Haloalkyl is a mono- or poly-halo-substituted alkyl. The alkyl moiety can be substituted by a plurality of identical halogen atoms or, alternatively, by different halogen atoms. When C₁-C₂₀alkyl is mono- or poly-halo-substituted, there are, for example, from 1 to 3, or 1 or 2, halogen substituents present on the alkyl moiety.

Alkylene is linear or branched. Typical examples are methylene, ethylene, propylene, isopropylene, n-butylene, sec-butylene, isobutylene, tert-butylene, pentylene, hexylene, heptylene, 2,4,4-trimethylpentylene, 2-ethylhexylene, octylene, nonylene, decylene, undecylene, dodecylene, tetradecylene, pentadecylene, hexadecylene, heptadecylene, octadecylene, nonadecylene or icosylene.

Cycloalkyl is for example cyclopropyl, cyclopentyl, cyclohexyl or cyclooctyl, especially cyclopentyl or cyclohexyl, preferably cyclohexyl.

Phenylalkyl is, for example, benzyl, α-methylbenzyl, α,α-dimethylbenzyl or 2-phenylethyl. For example benzyl and α,α-dimethylbenzyl.

Cycloalkylidene is for example substituted by from 1 to 3, for instance 1 or 2, branched or unbranched C₁-C₄alkyl groups, and is for example cyclopentylidene, methylcyclopentylidene, dimethylcyclopentylidene, cyclohexylidene, methylcyclohexylidene, dimethylcyclohexylidene, trimethylcyclohexylidene, tert-butylcyclohexylidene, cycloheptylidene or cyclooctylidene. For example cyclohexylidene and tert-butylcyclohexylidene.

Compounds selected from the group consisting of the organic phosphorus stabilizers and the hindered nitroxyl stabilizers may be used in any combination; or likewise certain compounds may be used singly.

The stabilizers according to this invention are effective at very low levels. The stabilizer is chosen for optimal balance of shelf stability and photocure response. At the effective low levels of stabilizer, the photocure response is not inhibited. For example, the present stabilizers are present from about 50 ppm to about 3 pph, by weight, based on the weight of the onium salt photoinitiator. For instance, the present stabilizers are present from about 100 ppm to about 2 pph, from about 200 ppm to about 2 pph, from about 250 ppm to about 1 pph, or from about 750 ppm to about 1 pph by weight, based on weight of the onium salt phtoinitiator.

The present stabilizers may be employed to provide shelf life stability to a formulated cationically photocurable composition, or likewise, may be added directly to an onium salt photoinitiator, and thereby provide shelf life stability to a subsequent formulated curable composition.

Accordingly, another subject of this invention is a cationic photoinitiator composition comprising
at least one onium salt photoinitiator and
an effective stabilizing amount of at least one compound selected from the group consisting of the organic phosphorus stabilizers and the hindered nitroxyl stabilizers.

Sensitizers may be present in the compositions of this invention and are, for example, compounds of the aromatic hydrocarbon class, typically anthracene and its derivatives, of the group of the xanthones, benzophenones and the derivatives thereof, such as Michler's ketone, Mannich bases or bis(p-N,N-dimethylaminobenzylidene)acetone. Thioxanthone and the derivatives thereof are also suitable, typically isopropylthioxanthone or dyes, such as acridines, triarylmethanes, e.g. malachite green, indolines, thiazines, e.g. methylene blue, oxazines, phenazines, typically safranine, or rhodamines. Aromatic carbonyl compounds are particularly suitable, such as benzophenone, thioxanthone, anthraquinone and 3-acylcuomarine derivatives, and also 3-(aroylmethylene thiazolines, as well as eosine, rhodanine and erythrosine dyes.

Preferred sensitisers are those selected of the group consisting of the anthracenes, xanthones, benzophenones and thioxanthones, preferably isopropylthioxanthone.

Typical examples of suitable sensitisers are 2,4-diethylthioxanthone; isopropylthioxanthone mixture of 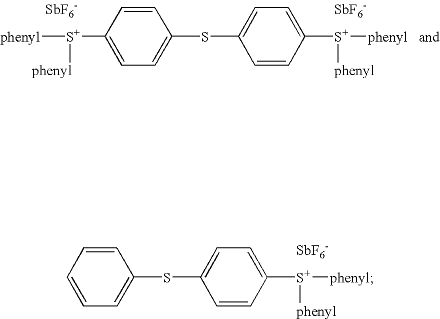
mixture of

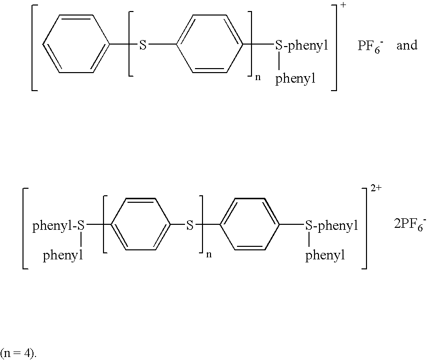

It is also possible to use electron donor compounds, such as, for example, alkyl- and aryl- amine donor compounds, in the composition. Such compounds are, for example, 4-di-methylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-trimethoxybenzene. Such donor compounds are preferably used in a concentration of from 0.01 to 5%, especially in a concentration of from 0.05 to 0.50%, based on the formulation.

Further examples of suitable photosensitisers are

Thioxanthones: thioxanthone, 2-isopropylthioxanthone, 2-chlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxy-carbonylthioxanthone, 3-butoxycarbonyl-7-methylthioxanthone, 1-chloro-4-propoxy-thioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxy-carbonyl-3-phenylsulfurylthioxanthone, 3,4-di[2-(2-methoxyethoxy)ethoxycarbonyl]thiox-anthone, 1-ethoxycarbonyl-3-(1-methyl-1-morpholinoethyl)-thioxanthone, 2-methyl-6-di-methoxymethylthioxanthone, 2-methyl-6-(1,1-dimethoxybenzyl)-thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxythioxanthone, 6-ethoxycarbonyl-2-methoxythioxanthone, 6-ethoxycarbonyl-2-methylthioxanthone, 1,3-dimethyl-2-hydroxy-9H-thiox-anthen-9-one-2-ethylhexyl ether, thi-oxanthone-2-polyethylene glycol ester, 2-hydroxy-3-(3,4-dimethyl-9-oxo-9H-thioxanthon-2-yloxy)-N,N,N-trimethyl-1-propanaminium chloride;

Benzophenones: benzophenone, 4-phenylbenzophenone, 4-methoxybenzophenone, 4,4′-dimethoxy-benzophenone, 4,4′-dimethylbenzophenone, 4,4′-dichlorobenzophenone, 4,4′-dimethyl-aminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl-2-benzoyl benzoate, 4-(2-hydroxyethylthio)-benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethyl-benzenemethanaminium chloride;

3-Acylcoumarins: 3-benzoylcoumarin, 3-benzoyl-7-methoxycoumarin, 3-benzoyl-5,7-di(propoxy)coumarin, 3-benzoyl-6,8-dichlorocoumarin, 3-benzoyl-6-chlorocoumarin, 3,3′-carbonyl-bis[5,7-di-(propoxy)coumarin], 3,3′-carbonyl-bis(7-methoxycoumarin), 3,3′-carbonyl-bis(7-diethyl-aminocoumarin), 3-isobutyroylcoumarin, 3-benzoyl-5,7-dimethoxycoumarin, 3-benzoyl-5,7-diethoxycoumarin, 3-benzoyl-5,7-dibutoxy-coumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)coumarin, 5,7-dimethoxy-3-(1-naphthoyl)coumarin, 3-benzoylbenzo-[f]-coumarin, 7-diethylamino-3-thienoylcoumarin, 3-(4-cyanobenzoyl)-5,7-dimethoxycoumarin;

3-(Aroylmethylene)-thiazolines: 3-methyl-2-benzoylmethylene-β-naphthothiazoline, 3-methyl-2-benzoylmethylene-benzo-thiazoline, 3-ethyl-2-propionylmethylene-β-naphthothiazoline; and

Other carbonyl compounds: acetophenone, 3-methoxyacetophenone, 4-phenylacetophenone, benzil, 2-acetyl-naphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethyl-aminobenzylidene)ketones, such as 2-(4-dimethylaminobenzylidene)-indan-1-one or 3-(4-dimethylamino-phenyl)-1-indan-5-yl-propenone, 2-benzoyl-3-(4-dimethylaminophenyl)-2-propene-nitrile, 3-phenylthiophthalimide, N-methyl-3,5-di(ethylthio)phthalimide, N-methyl-3,5-di(ethylthio)phthalimide.

Further suitable sensitizers are disclosed for example in U.S. Pat. No. 6,025,406, the disclosure of which is hereby incorporated by reference.

Sensitizers are present in the formulation to be cured in an amount of about 0.05 to about 10% by weight, e.g. of about 0.1 to 5% by weight, preferably of about 0.1 to 2% by weight, based on the weight of the curable formulation.

The compositions according to the invention may additionally comprise further photoinitiators, such as, for example, cationic photoinitiators, photo acid formers in amounts of from 0.01 to 15%, for example from 0.1 to 5%, by weight, based on the weight of the composition.

Examples of cationic photoinitiators and acid-formers are phosphonium salts, diazonium salts, pyridinium salts, sulfonium salts, ferrocenium salts, e.g. (η⁶-isopropylbenzene)(η⁵-cyclopentadienyl)-iron-II hexafluorophosphate®Irgacure 261, nitrobenzylsulfonates, alkyl- and aryl-N-sulfonyloxyimides and further known alkylsulfonic acid esters, haloalkylsulfonic acid esters, 1,2-disulfones, oxime sulfonates, benzoin tosylate, tolylsulfonyloxy-2-hydroxy-2-methyl-1 -phenyl-1-propanone and further known beta-ketosulfones, beta-sulfonylsulfones, bis(alkylsulfonyl)diazomethane, bis(4-tert-butyl-phenyl-sulfonyl)-diazomethane, benzoyl-tosyl-diazomethane, iminosulfonates and imidosulfonates and trichloromethyl-s-triazines and other haloalkyl-group-containing compounds and further compounds.

Further additional additives may be present in the curable compositions of this invention. Such additional additives are added to the compositions in amounts customary in the art and generally known to the skilled person. Typical examples of such additives are light stabilizers such as UV absorbers, typically those of the hydroxyphenylbenztriazole, hydroxyphenylbenzophenone, oxalic acid amide or hydroxyphenyl-s-triazine type. These compounds may be used singly or in admixture with or without the addition of sterically hindered amines (HALS).

Other customary additives include thermal inhibitors, optical brighteners, fillers and pigments, as well as white and colored pigments, dyes, antistatics, adhesion promoters, wetting agents, flow auxiliaries, lubricants, waxes, anti-adhesive agents, dispersants, emulsifiers, antioxidants, fillers, e.g. talcum, gypsum, silicic acid, rutile, carbon black, zinc oxide, iron oxides, reaction accelerators, thickeners, matting agents, antifoams, and other adjuvants customary, for example, in lacquer and coating technology.

The present compositions may comprise dyes and/or white or colored pigments. Depending upon the intended use, it is possible to use both inorganic and organic pigments. Such additives are known to the person skilled in the art; some examples thereof are titanium dioxide pigments, for example of the rutile or anatase type, carbon black, zinc oxide, such as zinc white, iron oxides, such as iron oxide yellow, iron oxide red, chromium yellow, chromium green, nickel titanium yellow, ultramarine blue, cobalt blue, bismuth vanadate, cadmium yellow and cadmium red. Examples of organic pigments are mono- or bis-azo pigments, and metal complexes thereof, phthalocyanine pigments, polycyclic pigments, such as, for example, perylene, anthraquinone, thioindigo, quinacridone and triphenylmethane pigments, and diketo-pyrrolo-pyrrole, isoindolinone, e.g. tetrachloro-isoindolinone, isoindoline, dioxazine, benzimidazolone and quinophthalone pigments.

The pigments can be used individually or in admixture in the formulations. Depending upon the intended use, the pigments are added to the formulations in amounts customary in the art, for example in an amount of from about 1 to about 60% by weight, or from about 10 to about 30% by weight, based on the total weight.

The formulations may, for example, also comprise organic dyes of a wide variety of classes. Examples thereof include azo dyes, methine dyes, anthraquinone dyes and metal complex dyes. Customary concentrations are, for example, from about 0.1 to about 20%, especially from about 1 to about 5%, based on the total weight.

The pigments, latent pigments or dyes or differently colored precursors of such pigments and dyes that are added may be so selected that they undergo a color change in the presence of the acid formed from the onium salt as a result of irradiation. Such compositions then show, by the color change, that they have been irradiated and can be used, for example, as irradiation dose indicators, e.g. for UV radiation, electron beams, X-rays, etc.

The choice of additives will depend upon the field of use in question and upon the properties desired for that field. The additives described above are customary in the art and are accordingly used in amounts customary in the art.

The present curable compositions may also comprise thermally curable components.

The present curable compositions may also comprise free-radically polymerizable components such as ethylenically unsaturated monomers, oligomers or polymers. Suitable materials contain at least one ethylenically unsaturated double bond and are capable of undergoing addition polymerization.

When free-radically polymerizable components are added to the compositions of this invention, it may be advantageous to add one or more suitable free-radical photoinitiator, for example benzophenone and derivatives thereof, acetophenone and derivatives thereof or mono- or bis-acylphosphine oxides.

Free-radically curable compounds and free-radical photoinitiators are for example disclosed in U.S. Pat. No. 6,306,555, incorporated herein by reference.

The compositions according to the invention can be used in numerous applications, for example in cationically radiation curable printing inks, in cationically radiation curable coating compounds which may or may not be pigmented, in cationically radiation curable adhesives, coatings and moldings, including glass fiber reinforced and carbon fiber reinforced composites and inner and outer layers of printed circuit boards.

The compositions according to the invention include also adhesives, as used, for example, for adhesive bonding (DVD bonding) in the manufacture of digital versatile disks (DVD) and as described, for example, in: WO 99/66506, WO 99/63017, JP 11241055 A2 Heisei, JP 11181391 A2 Heisei, WO 98/31765, and also as radiation curable laminating adhesives for flexible packaging (see, e.g., U.S. Pat. No. 5,328,940), optical adhesives (e.g. German Patent Application DD 225985) and pressure sensitive adhesives (e.g. U.S. Pat. No. 4,988,741 and EP 115870).

The compositions according to the invention are advantageously used where there is a need for hard coatings, adhesive bonds or photopolymerized dimensionally stable three dimensional moldings (e.g. for rapid prototyping) having good adhesion to paper, glass, metal, silicon, polycarbonate, acrylate polymers and other polymer substrates, and that exhibit only slight shrinkage during curing.

This curable compositions of this invention are employed for example for coating materials, in printing colors, clear coating formulations, white enamels, such as for wood or metals, or for paints, e.g. for paper, wood, metal or plastics.

The compositions according to the invention may be used for a variety of purposes, for example as printing inks, such as screen-printing inks, flexo printing inks or offset printing inks, as clear lacquer, as colored surface-coating compositions, as white surface-coating compositions, e.g. for wood or metal, as powder coating compositions, as paint, inter alia for paper, wood, metal or plastics, as daylight-curable paint for marking structures and roads, for photographic reproduction processes, for holographic recording materials, for image-recording processes or for the production of printing plates that are to be developed with organic solvents or using aqueous-alkaline media, in the production of masks for screen-printing, as dental filling compounds, as radiation-curable adhesives, as pressure-sensitive adhesives, as anti-adhesive coatings, as laminating resins, as photoresists, e.g. galvano-resists, etch resists or permanent resists, liquid films and dry films, as photostructurable dielectrics, and as solder masks for electronic circuits, as resists in the manufacture of color filters for any type of screen or for producing structures in the manufacture of plasma displays and electroluminescent displays, in the manufacture of optical switches, optical gratings (interference gratings), in the coating or sealing of electronic components, e.g. as electroinsulating compounds, or as coatings for optical fibers, for coil coating, as indicator systems for UV radiation, X-rays and electron beams, and in the manufacture of three-dimensional articles, e.g. for stereolithography and for composites, e.g. for composites reinforced with glass or carbon or graphite fibers. The compositions are also suitable for the manufacture of optical lenses, e.g. contact lenses or Fresnel lenses, and also in the manufacture of medical apparatus, aids or implants.

The photocurable compositions according to the invention are suitable, for example, as coating materials for all kinds of substrates, for example wood, textiles, paper, ceramics, glass, marble, plastics, such as polyester, polyethylene terephthalate, polyolefins or cellulose acetate, especially in the form of films, and metals, such as Al, Cu, Ni, Fe, Zn, Mg or Co and GaAs, Si or SiO₂, to which a coating is to be applied or an image is to be applied by image-wise exposure, or to which a structured resist layer is to be applied.

The coating of the substrates can be effected by applying a liquid composition, a solution or suspension to the substrate. The choice of solvent and the concentration are governed chiefly by the nature of the composition and by the coating method. The solvent should be inert, that is to say it should not enter into any chemical reaction with the components and it should be capable of being removed again upon drying after the coating operation. Examples of suitable solvents are ketones, ethers and esters, such as methyl ethyl ketone, isobutyl methyl ketone, cyclopentanone, cyclohexanone, 2-heptanone, methyl amyl ketone, N-methylpyrrolidone, gamma-butyrolactone, dioxane, tetrahydrofuran, 2-methoxyethanol, 2-ethoxyethanol, 1-methoxy-2-propanol, 1,2-dimethoxyethane, acetic acid ethyl ester, acetic acid n-butyl ester, propylene glycol monomethyl ether acetate, lactic acid ethyl ester, propylene carbonate and 3-ethoxy-propionic acid ethyl ester. After coating of the substrates, the solvent is generally removed by drying.

The formulation is applied uniformly to a substrate by known coating methods, for example by spin-coating, immersion, knife coating, curtain pouring, brush application or spraying, especially by electrostatic spraying and reverse-roll coating, and by electrophoretic deposition. It is also possible to apply the photosensitive layer to a temporary flexible support and then coat the final substrate, e.g. a copper-laminated printed circuit board, by transferring the layer by lamination.

The amount applied (layer thickness) and the type of substrate used (layer substrate) depend of the desired field of application. The layer thickness is usually in the range from about 0.1 to about 100 μm, for example from about 0.1 μm up to about 50 μm, e.g. from about 4 μm to about 15 μm.

Another field of application for the present compositions is metal coating, typically for painting metal sheets and tubes, cans or bottle caps. In this case, suitable substrates are in particular metals, such as aluminium or tinplate.

In the process of curing the present compositions, ultraviolet (UV) irradiation is usually carried out with light having a wavelength in the range of 200 nm to 600 nm. Suitable radiation includes e.g. sun light or light from artificial light sources. Light sources to be used include a great number of a very wide range of types. Suitable light sources are point sources as well as arrays of reflector lamps (lamp carpets). Typical examples are: carbon arc lamps, xenon arc lamps, mercury (medium, high and low pressure) lamps, where desired doped with metal halides (metal halide lamps), microwave-excited metal vapor lamps, excimer lamps, superactinic neon lamps, fluorescent lamps, argon filament lamps, flash bulbs, photographic flood light lamps, electron beams and X-rays. The distance between the lamp and the substrate to be irradiated can vary depending on the end use requirement and type of lamp or lamp intensity, e.g. from about 2 cm to about 150 cm. Laser light sources are also suitable, e.g. excimer laser. It is also possible to use laser in the visible range.

The radiation sensitive compositions according to the invention are used, for example, as negative resists that have very high photosensitivity and that can be developed in an aqueous alkaline medium without swelling. They are suitable as photoresists for electronics, such as galvanoresists, etch resists, and in liquid and dry films, solder resists, as resists in the production of color filters for any type of screen, or to form structures in the manufacture of plasma displays and electroluminescent displays, in the manufacture of printing plates, e.g. offset printing plates, in the manufacture of printing molds for letterpress printing, flatbed printing, intaglio printing, flexo printing or screen-printing molds, the production of relief copies, e.g. for the production of texts in braille, for the production of stamps, for use in the etching of moldings or for use as a microresist in the manufacture of integrated switching circuits. The compositions can also be used as photostructurable dielectrics, for encapsulating materials or as an insulating coating in the manufacture of computer chips, printed circuits and other electrical or electronic components. The possible layer supports and processing conditions for the coated substrates vary accordingly.

The compositions according to the invention are also used in the manufacture of single or multi layer materials for image recording or image reproduction (copies, reprography), which may be monochromatic or polychromatic. Included therein are materials for holographic storage of information, e.g. for holographic images or 3-dimensional holographic data storage. Such materials can also be used in color test systems. In that technology it is also possible to use formulations that comprise microcapsules and, to produce the image, a thermal step can be carried out after the exposure step. Such systems and technologies and their use are described, e.g., in U.S. Pat. No. 5,376,459.

For photographic recordings of information there are used, for example, films of polyester, cellulose acetate or plastics-coated papers; for offset printing molds there is used specially treated aluminum; for the production of printed circuits there are used copper coated laminates; and for the production of integrated switching circuits there are used silicon wafers. The layer thicknesses for photographic materials and offset printing molds are generally from about 0.5 μm to 10 μm, and for printed circuits from 1.0 μm to about 100 μm.

The invention relates also to the use of the present compositions in the manufacture of surface coating compositions, printing inks, printing plates, dental compounds, stereolithography resins, adhesives, anti-adhesive coatings, color filters, resist materials or image recording materials.

The invention relates also to a coated substrate that is coated on at least one surface with a composition according to the invention, and to a method for the production of relief images wherein a composition according to the invention is applied to a substrate and is then exposed image wise.

The expression “image wise exposure” includes irradiation through a mask that contains a predetermined pattern, for example a diapositive, a metal mask, a chrome mask on a transparent support, exposure by means of a laser beam that is moved, for example controlled by a computer, over the surface of the coated substrate and in that manner produces an image, and irradiation with computer-controlled electron beams. Images can also be produced by interference between two beams or images, for example for holographic uses. It is also possible to use liquid crystal masks that can be actuated pixel by pixel to produce digital images, as described, for example, by A. Bertsch, J. Y. Jezequel, J. C. Andre in Journal of Photochemistry and Photobiology A: Chemistry 1997, 107, pp. 275-281 and by K.-P. Nicolay in Offset Printing 1997, 6, pp. 34-37.

As already mentioned, the compositions of this invention can be used in photoresists. Resist systems can be obtained by image wise exposure of formulations comprising the present components and a subsequent development step. The term “photoresist” is not limited to the chemically enhanced resists described in greater detail below, but includes all resist materials in which reactions are initiated by the radiation-chemical production of acid and that, in a development step, result in a difference in solubility between exposed and non-exposed regions. For example, also included are resists that can be processed in an aqueous medium, as described, for example, in U.S. Pat. No. 5,998,092 and in SPIE, Vol. 3999, pp. 569-578 (2000) as well as resists based on a Pinacol rearrangement, as described, for example, in SPIE, Vol. 3999, pp. 62-73 (2000).

Accordingly, the invention relates also to a photoresist composition that comprises at least one onium salt photoinitiator and an effective stabilizing amount of at least one compound selected from the group consisting of the organic phosphorus stabilizers and the hindered nitroxyl stabilizers.

A chemically enhanced photoresist is to be understood as being a resist formulation in which the radiation sensitive component provides a catalytic amount of acid, which in turn catalyzes a chemical reaction of at least one acid sensitive component of the resist. This results in a difference in the solubility of the irradiated and non irradiated portions of the resist. As a result of the catalytic nature of that process, an acid molecule can initiate reactions at many sites because it diffuses through the reactive polymer matrix from one reaction site to the next, provided it is not captured or destroyed by secondary reactions. Even a low acid concentration is therefore sufficient to obtain large differences in solubility between irradiated and non-irradiated portions of the resist. It is therefore generally sufficient to add only a small amount of latent acid compound. It is necessary, however, for the latent acid donors to be chemically and thermally stable until they are being irradiated. It is also necessary for the latent catalysts to be readily soluble in the liquid resist formulation and in the solid resist film in order to avoid the formation of particles which would adversely affect the use of the resists in microelectronic processing processes.

It will be clear from the above remarks that chemical and thermal stability of the latent acid donor (onium salt photoinititor) is essential for its use in chemically enhanced photoresists.

The difference in solubility between exposed and non-exposed areas in the resist, which results from the action of the acid catalyzed reaction, depends upon the other components in the resist. If the compositions according to the invention comprise components that increase the solubility of the composition in the developer after irradiation and optionally after thermal aftertreatment, then it is a positive photoresist.

The invention accordingly relates also to a positive photoresist.

If, however, the components of the composition lower the solubility in the developer after irradiation and optionally after thermal aftertreatment, then it is a negative photoresist.

The invention accordingly relates also to a negative photoresist.

An overview of chemically enhanced photoresists can be found, for example, in: H. Ito, IBM Journal of Research and Development, Vol. 41, No. 1/2, page 69 (1997); H. Ito, SPIE Vol. 3678, page 2 (1999); for negative resists in: J .M. Shaw et al. IBM Journal of Research and Development, Vol. 41, No. 1/2, page 81 (1997). Chemically enhanced positive photoresist systems are described, for example, in E. Reichmanis, F. M. Houlihan, O. Nalamasu, T. X. Neenan, Chem. Mater. 1991, 3, 394; or in C. G. Willson, “Introduction to Microlithography, 2nd. Ed.; L. S. Thompson, C. G. Willson, M. J. Bowden, Eds., Amer. Chem. Soc., Washington D.C., 1994, p. 139.

The proportion of the onium salt compounds in the positive resist formulation is advantageously from about 0.01 to about 20% by weight, based on the solids content in the photoresist.

The use of the onium salts in chemically enhanced systems based on the principle of the removal of protecting groups from a polymer normally results in a positive resist. Positive resists are preferred to negative resists in many applications, especially because of their better resolution. There is, however, also interest in producing negative images using the positive resist mechanism, in order to combine the advantages of the good resolution of the positive resist with the properties of a negative resist. This is effected, for example, by the introduction of a so-called image-reversal step, as described, for example, in EP 361906. For that purpose, the resist material, after image-wise exposure, is treated, for example, with a gaseous base, before development, the acid that is formed being neutralised image-wise. The entire resist is then exposed and subjected to thermal treatment, and the negative image is developed in the customary manner.

Acid sensitive components that form negative resists are generally compounds that are capable of undergoing a crosslinking reaction with themselves and/or with one or more further components in the composition when they are catalyzed by an acid (e.g. the acid formed by exposure of the onium salt compounds in the presence of the stabilizers according to the invention). Compounds of that kind are, for example, the known acid-curable resins, such as acrylate, polyester, alkyd, melamine, urea, epoxy and phenolic resins or mixtures thereof. Amino resins, phenolic resins and epoxy resins are especially suitable. Acid-curable resins of that kind are generally known and are described, for example, in “Ullmann's Encyclopatdie der technischen Chemie”, Edition 4, Vol. 15 (1978), pp. 613-628. The crosslinking components should advantageously be present in a concentration of about from 2 to 40% by weight, preferably from 5 to 30% by weight, based on the solids content of the negative resist formulation.

The concentration of the onium salt compounds in the negative resist is advantageously from about 0.1 to about 30% by weight, especially up to about 20% by weight, preferably from about 1 to about 15% by weight, based on the total solids content of the compositions.

Normally the compositions according to the invention are dissolved in a suitable solvent before application to the substrate. Examples of such solvents include ethylene dichloride, cyclohexanone, cyclopentanone, 2-heptanone, γ-butyrolactone, methyl ethyl ketone, ethylene glycol monomethyl ether, ethylene glycol monoethyl ether, 2-methoxyethyl acetate, 2-ethoxyethyl acetate, 2-ethoxyethanol, diethyl glycol dimethyl ether, ethylene glycol mono-ethyl ether acetate, propylene glycol monomethyl ether, propylene glycol monomethyl ether acetate, toluene, ethyl acetate, methyl lactate, ethyl lactate, methylmethoxy propionate, ethylethoxy propionate, methyl pyruvate, ethyl pyruvate, propyl pyruvate, N,N-dimethyl-formamide, dimethyl sulfoxide, N-methylpyrrolidone and tetrahydrofuran. Such solvents can be used individually or in combinations. Preferred examples thereof are esters, such as 2-methoxyethyl acetate, ethylene glycol monoethyl ether acetate, propylene glycol mono-methyl ether acetate, methylmethoxy propionate, ethylethoxy propionate and ethyl lactate.

A surfactant may be added to the solvent. Examples of suitable surfactants are non-ionic surfactants, such as polyoxyethylene alkyl ethers, e.g. polyoxyethylene lauryl ether, polyoxyethylene stearyl ether, polyoxyethylene acetyl ether and polyoxyethylene oleyl ether; polyoxyethylene alkyl aryl ethers, e.g. polyoxyethylene octyl phenol ether and polyoxyethylene nonyl phenol ether; polyoxyethylene/polyoxypropylene block copolymers, sorbitol/fatty acid esters, e.g. sorbitol monolaurate, sorbitol monopalmitate, sorbitol monostearate, sorbitol monooleate, sorbitol trioleate; fluorochemical surfactants, such as F-top EF301, EF303 and EF352 (New Akita Chemical Company, Japan), Megafac F171 and F17.3 (Dainippon Ink & Chemicals, Inc, Japan), Fluorad FC 430 and FC431 (Sumitomo #M Ltd., Japan), Asahi Guard AG710 and Surflon S-382, SC101, SC102, SC103, SC104, SC105 and SC106 (Asahi Grass Col, Ltd., Japan); organosiloxane polymer KP341 (Shin-Etsu Chemical Co., Ltd., Japan); and acrylic or methacrylic (co)polymers Poly-flow Now.75 and NO.95 (Kyoeisha Chemical Co., Ltd., Japan). Generally the proportion of surfactant in the composition is about 2 parts by weight or less, e.g. 0.1 part by weight or less, per 100 parts by weight of solids content in the composition. The surfactants may be used individually or in combinations.

The solution of the composition according to the invention is applied uniformly to a substrate by means of generally known methods already described above. Suitable layer thicknesses have also already been indicated above.

After coating, the solvent is usually removed by heating and a layer of the photoresist remains on the substrate. The drying temperatures must, of course, be lower than the temperatures at which constituents of the resist formulation can decompose or react. Normally the drying temperatures vary within a range of about from about 60 to about 160° C.

The exposure of the coated substrates has already been described above. After exposure and, if necessary after the thermal treatment, the exposed sites of the composition (in the case of the positive resist) or the non-exposed sites of the composition (in the case of the negative resist) are removed using a developer in a manner generally known to a person skilled in the art.

In order to accelerate the catalytic reaction and thus to ensure the development of a sufficient difference in solubility between exposed and non-exposed areas of the resist coating, the coating is preferably heated before development. It is also possible to carry out heating during the exposure. Generally temperatures of from about 60 to about 160° C. are used. The optimum duration of heating depends upon the heating method used and can be determined by the person skilled in the art by simple experiments. It normally ranges from a few seconds to several minutes, e.g. from about 10 to about 300 seconds when a heating plate is used, and, e.g., from about 1 to about 30 minutes when a circulated-air oven is used.

Development is then carried out, wherein the portions of the coating that are soluble in the developer are removed. If necessary, the development step can be accelerated by gentle movement of the sample, careful brushing of the coating in the developer bath or by development in a spray developing apparatus. Aqueous-alkali developer fluids customary in the art can be used for that purpose. Examples thereof include sodium and potassium hydroxide, the corresponding carbonates, hydrogen carbonates, silicates and metasilicates, metal-free bases, such as ammonium compounds, or amines, such as ethylamine, n-propylamine, diethylamine, di-n-propylamine, triethylamine, methyldiethylamine, alkanolamines, e.g. dimethylethanolamine, triethanolamine, quaternary ammonium hydroxides, e.g. tetramethyl-ammonium hydroxide or tetraethylammonium hydroxide. The developer solutions are normally up to 0.5N, but are generally diluted before use in a suitable manner. For example, solvents having a normality of about from 0.1 to 0.3 are very suitable. The choice of developer will depend upon the nature of the photocurable coating, especially upon the nature of the crosslinking agent or the resulting photolysis products. The aqueous developer solutions may, if necessary, also comprise small amounts of wetting agents and/or organic solvents. Examples of typical organic solvents that may be added to the developer solutions include cyclohexanone, 2-ethoxyethanol, toluene, acetone, isopropanol and mixtures of two or more such solvents. A typical aqueous/organic developer system is a system based on Butylcellosolve®/water.

The invention relates also to a method of manufacturing a photoresist by
(1) applying a composition as described above to a substrate;
(2) heating the composition to a temperature of from about 60° C. to about 160° C.;
(3) carrying out image-wise exposure with light of a wavelength of from about 150 nm to about 1500 nm;
(4) optionally heating the composition to temperatures of from about 60° C. to about 160° C.; and
(5) subsequently developing with a solvent or an aqueous alkaline developer.

The photoresist compositions can be used on all types of substrate and with all irradiation techniques known to the person skilled in the art. For example, semiconductor substrates can be used, such as silicon, gallium arsenide, germanium, indium antimonide; also substrates covered by oxide or nitride layers, such as silicon dioxide, silicon nitride, titanium nitride, siloxanes, and metal substrates and metal-coated substrates coated with metals such as aluminium, copper, tungsten, etc. The substrate can also be coated with polymeric materials, for example with organic antireflective coatings, insulation layers and dielectric coatings made of polymeric materials.

The photoresist layer can be irradiated by all customary techniques, such as direct writing, i.e. with a laser beam or projection lithography in step-and repeat mode or scanning mode, or by contact printing through a mask.

In the case of projection lithography, a large number of optical conditions can be selected, such as coherent, partially coherent or incoherent radiation. This includes non-axial irradiation techniques, for example annular illumination and quadrupolar irradiation where the radiation is allowed to pass through only certain regions of the lens, excluding the center of the lens.

The mask used to produce the pattern can be a hard mask or a flexible mask. The mask can include transparent, semi-transparent and opaque patterns. The pattern size can include also patterns that are at or below the resolution limit of the projection optics and are arranged on the mask in a certain manner in order to modify the aerial image, intensity and phase modulation of the radiation after having it has passed through the mask. This includes phase-shift masks and half-tone phase-shift masks.

The process for forming an image on the photoresist composition can be used to generate patterns of any desired geometry and shape, for example dense and isolated lines, contact holes, channels, incisions, dots, etc.

Preference is given to a method wherein the image-wise exposure is effected by monochromatic or polychromatic radiation in the wavelength range of from about 190 to about 450 nm, for example from about 190 to about 260 nm.

The invention relates also to the use of the present onium salt compounds in the presence of the stabilizers as photolatent acid donors in the polymerization or crosslinking of cationically or acid-catalytically polymerizable or crosslinkable compounds or to increase the solubility of compounds that increase their solubility in a developer under the action of acid, and also to a method for the photopolymerization or crosslinking of cationically or acid-catalytically polymerizable or crosslinkable compounds under the action of electromagnetic radiation, in which method the onium salt compounds in the presence of the stabilizers are used as photolatent acid donors.

The UV irradiation to release the acid is generally effected with light of a wavelength of from about 157 to about 600 nm. Suitable radiation is present, for example, in sunlight or light from artificial light sources. A large number of widely varying types of light source may be used. Point sources and also planiform radiators (lamp carpets) are suitable. Examples thereof include: carbon arc lamps, xenon arc lamps, medium-, high- and low-pressure mercury lamps, doped where appropriate with metal halides (metal halide lamps), microwave-excited metal vapor lamps, excimer lamps, superactinic fluorescent tubes, fluorescent lamps, argon incandescent lamps, flashlamps, photographic flood lights, electron beams and X-rays.

Laser light sources, for example excimer lasers, are also suitable. Lasers in the visible range can also be used.

The distance between the lamp and the substrate to be exposed can vary according to the intended use and the type and strength of the lamp and may be, for example, from about 2 cm to about 150 cm.

Accordingly, also disclosed is a method for curing a cationically polyerizable composition,
which method comprises
   applying a compositon comprising
      at least one cationically polymerizable compound,
      at least one onium salt photoinitiator and
      at least one compound selected from the group consisting of the organic phosphorus stabilizers and the hindered nitroxyl stabilizers to a substrate and
exposing the composition for a suitable time to ultraviolet radiation.

The following Examples illustrate the invention.

The following compounds are employed in the working Examples. Unless otherwise indicated, all parts and percentages are by weight.
Cationically Curable Resins: 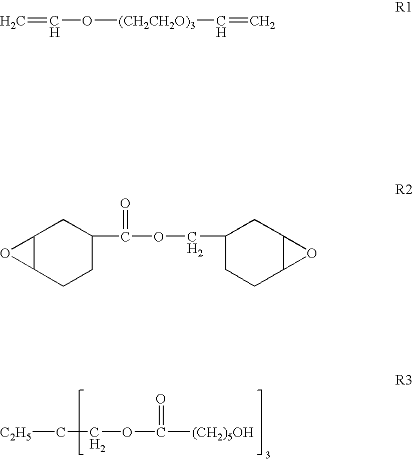
Photoinitiators: 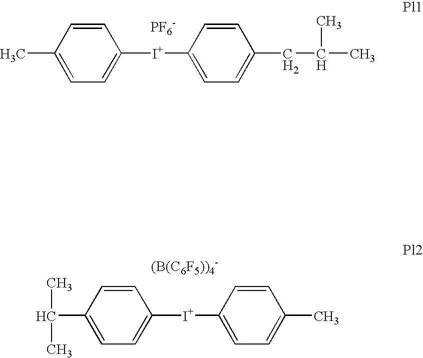
Organic Phosphorus Stabilizers: 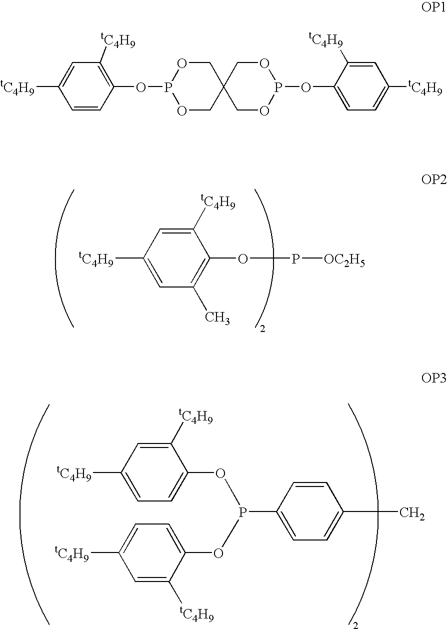
Hindered Nitroxyl Stabilizers:

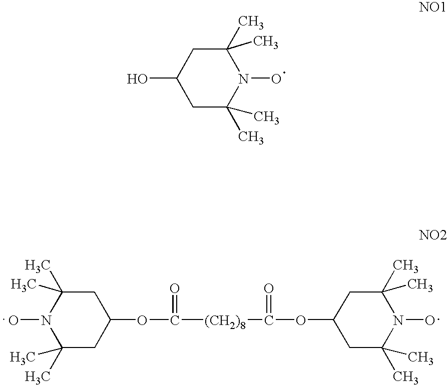

### EXAMPLE 1

A photocurable composition is prepared with a 25:25:50 weight mixture of resins R2:R3:R1 and 2.7 pph, by weight, of cationic photoinitiator PI1. The fresh composition exhibits a viscosity of 16 cps. After a period of 6 months at room temperature, the unstabilized formulation exhibits a viscosity of 46 cps. After 6 months at room temperature, a stabilized formulation with 0.025 pph nitroxyl stabilizer NO1 has a viscosity of 23 cps.

### EXAMPLE 2

Photocurable compositions are prepared with a 3:1 weight ratio of resins R2:R3. The samples are tested for oven stability at 80° C. The samples contain 2.7 pph by weight photoinitiator PI1. Without stabilizers, samples gel between 12 and 14 days. With an added 0.25 pph by weight nitroxyl stabilizer NO1, the sample does not gel until 35 days. With an added 1 pph by weight of either of organic phosphorus stabilizer OP2 or OP3, the samples gel at about the 27^{th} day. With 1 pph by weight of the organic phosphorus stabilizer OP1, the sample does not gel until day 39.

### EXAMPLE 3

Photocurable compositions are prepared with a 3:1 weight ratio of resins R2:R3. The samples are tested for oven stability at 80° C. The samples contain 1 pph by weight photoinitiator PI2 and 0.5 pph by weight the sensitizer isopropylthioxanthone. Shelf life stability of formulations containing further additives is shown below.

| NO1 pph | OP1 pph | days to gel |
|---|---|---|
| — | — | 1 |
| 0.006 | — | 7 |
| 0.006 | 0.5 | 9 |
| 0.006 | 1 | 11 |
| 0.0125 | — | 7 |
| 0.0125 | 0.5 | 14 |
| 0.0125 | 1 | 16 |
| — | 0.5 | 5 |
| — | 1 | 8 |

When extrapolated to room temperature, it is estimated that the shelf life for the most stable formulations is greater than 2 years. The combination of stabilizers of the hindered nitroxyl class and the organic phosphorus class is synergistic toward providing stable formulations.

We claim:

1. A cationic photocurable composition with improved shelf life stability comprising
at least one cationically polymerizable compound,
at least one iodonium salt photoinitiator and
an effective stabilizing amount of at least one compound selected from the group consisting of organic phosphorus stabilizers.

2. A composition according to claim 1 where the iodonium salt photoinitiators are of the formula
(R₁−I−R₂)⁺·(A⁻) (I),
where
R₁ and R₂ are each independently of the other phenyl which is unsubstituted or is substituted by C₁-C₂₄alkyl, C₁-C₂₄alkoxy, —NO₂, —Cl, —Br, —CN, —COOR₃, —SR₃ or 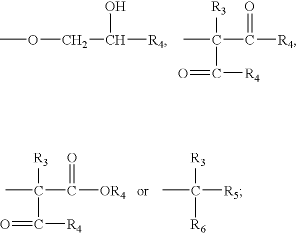
or R₁ and R₂ together are a radical 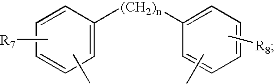
n is a number from 0 to 6;
R₃ is hydrogen or C₁-C₁₂alkyl;
R₄ is C₁-C₁₈alkyl or phenyl;
R₅ and R₆ are —CN, or R₅ is —NO₂, and R₆ is phenyl;
R₇ and R₈ are each independently of the other C₁-C₂₄alkyl, C₁-C₂₄alkoxy, —NO₂, —Cl, —Br, —CN, —COOR₃, or —SR₃; and
A⁻ is an anion selected from the group consisting of (BF₄)⁻, (SbF₆)⁻, (PF₆)⁻, (B(C₆F₅))₄—, C₁-C₂₀alkylsulfonate, C₂-C₂₀haloalkylsulfonate, unsubstituted C₆-C₁₀arylsulfonate, camphor- sulfonate, C₁-C₂₀-perfluoroalkylsulfonylmethide, C₁-C₂₀-perfluoroalkylsulfonylimide, and C₆-C₁₀arylsulfonate substituted by halogen, —NO₂, C₁-C₁₂alkyl, C₁-C₁₂halo-alkyl, C₁-C₁₂alkoxy or by COOR₁.

3. A composition according to claim 2 where in the iodonium salt photoinitiators R₁ and R₂ are each independently of the other phenyl which is unsubstituted or substituted by C₁-C₂₄alkyl, C₁-C₂₄alkoxy, —NO₂, —Cl, —Br, —CN, —COOR₃ or —SR₃.

4. A composition according to claim 2 where in the iodonium salt photoinitiators R₁ and R₂ are C₁-C₂₄alkyl- or C₁-C₂₄alkoxy-substituted phenyl and A⁻ is selected from the group consisting of SbF₆⁻, PF₆⁻ and (B(C₆F₅))₄⁻ anions.

5. A composition according to claim 1 where the iodonium salt photoinitiators are selected from the group consisting of
bis(4-hexylphenyl)iodonium hexafluoroantimonate;
bis(4-hexylphenyl)iodonium hexafluorophosphate;
(4-hexylphenyl)phenyliodonium hexafluoroantimonate;
(4-hexylphenyl)phenyliodonium hexafluorophosphate;
bis(4-octylphenyl)iodonium hexafluoroantimonate;
(4-sec-butylphenyl)-(4′-methylphenyl)iodonium hexafluorophosphate;
(4-iso-proylphenyl)-(4′-methylphenyl)iodonium hexafluorophosphate
[4-(2-hydroxytetradecyloxy)phenyl]phenyliodonium hexafluoroantimonate;
[4-(2-hydroxydodecyloxy)phenyl]phenyliodonium hexafluoroantimonate;
bis(4-octylphenyl)iodonium hexafluorophosphate;
(4-octylphenyl)phenyliodonium hexafluoroantimonate;
(4-octylphenyl)phenyliodonium hexafluorophosphate;
bis(4-decylphenyl)iodonium hexafluoroantimonate;
bis(4-decylphenyl)iodonium hexafluorophosphate;
(4-decylphenyl)phenyliodonium hexafluoroantimonate;
(4-decylphenyl)phenyliodonium hexafluorophosphate;
(4-octyloxyphenyl)phenyliodonium hexafluoroantimonate;
(4-octyloxyphenyl)phenyliodonium hexafluorophosphate;
(2-hydroxydodecyloxyphenyl)phenyliodonium hexafluoroantimonate;
(2-hydroxydodecyloxyphenyl)phenyliodonium hexafluorophosphate;
bis(4-hexylphenyl)iodonium tetrafluoroborate;
(4-hexylphenyl)phenyliodonium tetrafluoroborate;
bis(4-octylphenyl)iodonium tetrafluoroborate;
(4-octylphenyl)phenyliodonium tetrafluoroborate;
bis(4-decylphenyl)iodonium tetrafluoroborate;
bis(4-(mixed C₈-C₁₄alkyl)phenyl)iodonium hexafluoroantimonate;
(4-decylphenyl)phenyliodonium tetrafluoroborate;
(4-octyloxyphenyl)phenyliodonium tetrafluoroborate;
(2-hydroxydodecyloxyphenyl)phenyliodonium tetrafluoroborate;
biphenylene iodonium tetrafluoroborate;
biphenylene iodonium hexafluorophosphate; and
biphenylene iodonium hexafluoroantimonate.

6. A composition according to claim 1 where the iodonium salt photoinitiators are selected from the group consisting of 4-isobutylphenyl-4′-methylphenyliodonium hexafluoro-phosphate; 4-isobutylphenyl-4′-methylphenyliodonium pentafluoroethylsulfonate; 4-iso-butylphenyl-4′-methylphenyliodonium tresylate; 4-isobutylphenyl-4′-methylphenyliodonium nonaflate; 4-isobutylphenyl-4′-methylphenyliodonium tosylate; 4-isobutylphenyl-4′-methyl-phenyliodonium 4-methoxyphenylsulfonate; 4-isobutylphenyl-4′-methylphenyliodonium 4-chlorophenylsulfonate; 4-isobutylphenyl-4′-methylphenyliodonium 4-fluorophenylsulfonate; 4-isobutylphenyl-4′-methylphenyliodonium 2,4,6-trimethylphenylsulfonate; 4-isobutylphenyl-4′-methylphenyliodonium 2,4,6-(tri-isopropyl)-phenylsulfonate; 4-isobutylphenyl-4′-methyl-phenyliodonium 4-dodecylphenylsulfonate; 4-isobutylphenyl-4′-methylphenyliodonium camphor-10-sulfonate; 4-isobutylphenyl-4′-methylphenyliodonium tetrakis(pentafluorophenyl)-borate; 4-isopropylphenyl-4′-methylphenyliodonium tetrakis(pentafluorophenyl)-borate; 4-(2-methylbut-2-yl)phenyl-4′-methylphenyliodonium hexafluorophosphate; 4-(2-methylbut-2-yl)phenyl-4′-methylphenyliodonium pentafluoroethylsulfonate; 4-(2-methylbut-2-yl)phenyl-4′-methylphenyliodonium tetrakis(pentafluorophenyl)borate; 4-(2-methylbut-2-yl)phenyl-4′-methylphenyliodonium hexafluorophosphate; 4-(2-methylbut-2-yl)phenyl-4′-methylphenyliodonium pentafluoroethylsulfonate; 4-(2-methylbut-2-yl)phenyl-4′-methyl-phenyliodonium nonaflate; 4-(2-methylbut-2-yl)phenyl-4′-methylphenyliodonium 4-trifluoro-methylphenylsulfonate; 4-(2-methylbut-2-yl)phenyl-4′-methylphenyliodonium tosylate; 4-(2-methylbut-2-yl)phenyl-4′-methylphenyliodonium camphor-10-sulfonate; 4-cyclohexyl-4′-methylphenyliodonium hexafluorophosphate; 4-cyclohexyl-4′-methylphenyliodonium penta-fluoroethylsulfonate; 4-cyclohexyl-4′-methylphenyliodonium camphor-10-sulfonate; 4-cyclohexyl-4′-methylphenyliodonium tetrakis(penta-fluorophenyl)borate; 4-cyclohexyl-4′-methyl-phenyliodonium tosylate; 4-tert-butylphenyl-4′-methylphenyliodonium hexafluoro-phosphate; 4-tert-butylphenyl-4′-methylphenyliodonium pentafluoroethylsulfonate; 4-tert-butylphenyl-4′-methylphenyliodonium camphor-10-sulfonate; 4-tert-butylphenyl-4′-methylphenyliodonium tetrakis(pentafluorophenyl)borate; 4-tert-butylphenyl-4′-methylphenyliodonium 4-chloro-phenylsulfonate; 4-tert-butylphenyl-4′-methylphenyliodonium 4-fluorophenylsulfonate; 4-tert-butylphenyl-4′-methylphenyliodonium 4-methoxyphenylsulf-o-nate; 4-tert-butylphenyl-4′-methylphenyliodonium hexafluorophosphate; 4-isobutylphenyl-4′-methylphenyliodonium nonafluorobutylsulfonate; 4-cyclohexyl-4′-methylphenyliodonium hexafluoroantimonate; 4-(2-methylbut-2-yl)phenyl-4′-methylphenyliodonium nonafluorobutyl-sulfonate; 4-isobutyl-phenyl-2′-methylphenyliodonium hexafluorophosphate; 4-isobutylphenyl-4′-ethylphenyl-iodonium hexafluorophosphate; and 4-(branched dodecyl)-4-methylphenyliodonium hexafluorophosphate.

7. A composition according to claim 1 where the the iodonium salt photoinitiators are present from about 0.05% to about 15% by weight, based on the weight of the composition.

8. A composition according to claim 1 where the iodonium salt photoinitiators are present from about 0.5% to about 10% by weight, based on the weight of the composition.

9. A composition according to claim 1 where the organic phosphorus stabilizers are of the formula (1), (2), (3), (4), (5), (6) or (7), 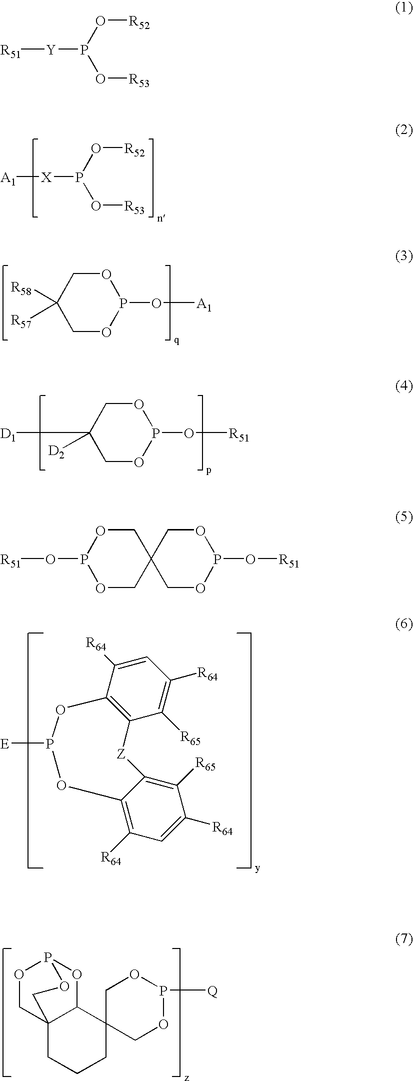
A₁, if n is 2, is C₂-C₁₈ alkylene; C₂-C₁₂ alkylene interrupted by oxygen, sulfur or —NR₅₄—; a radical of the formula 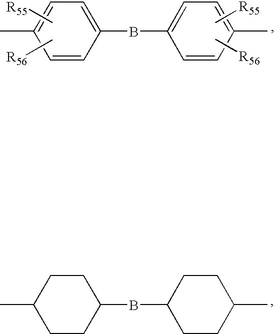
or phenylene;
A₁, if n is 3, is a radical of the formula —CᵣH₂ᵣ₋₁—;
A₁, if n is 4, is 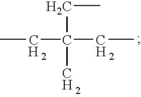
A₂ is as defined for A₁ if n is 2;
B is a direct bond, —CH₂—, —CHR₅₄—, —CR₅₁R₅₄—, sulfur, C₅-C₇cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂, if p is 1, is C₁-C₄ alkyl;
E, if y is 1, is C₁-C₁₈ alkyl, —OR₅₁ or halogen;
E, if y is 2, is —O—A₂—O—,
E, if y is 3, is a radical of the formula R₅₄C(CH₂O—)₃ or N(CH₂CH₂O—)₃;
Q is the radical of an at least z-valent alcohol or phenol, this radical being attached via the oxygen atom to the phosphorus atom;
R₅₁, R₅₂ and R₅₃ independently of one another are C₁-C₁₈ alkyl which is unsubstituted or substituted by halogen, —COOR₅₄, —CN or —CONR₅₄R₅₄; C₂-C₁₈ alkyl interrupted by oxygen, sulfur or —NR₅₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula 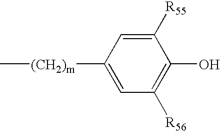
in which m is an integer from the range 3 to 6;
R₅₄ is hydrogen, C₁-C₁₈ alkyl, C₅-C₁₂ cycloalkyl or C₇-C₉ phenylalkyl,
R₅₅ and R₅₆ independently of one another are hydrogen, C₁-C₈ alkyl or C₅-C₆ cycloalkyl,
R₅₇ and R₅₈, if q is 2, independently of one another are C₁-C₄ alkyl or together are a 2,3-dehydropentamethylene radical; and
R₅₇ and R₅₈, if q is 3, are methyl;
R₆₄ is hydrogen, C₁-C₉ alkyl or cyclohexyl,
R₆₅ is hydrogen or methyl and, if two or more radicals R₆₄ and R₆₅ are present, these radicals are identical or different,
X and Y are each a direct bond or oxygen,
Z is a direct bond, methylene, —C(R₆₆)₂— or sulfur, and
R₆₆ is C₁-C₈ alkyl.

10. A composition according to claim 1 where the organic phosphorus stabilizers are selected from the group consisting of triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, bisisodecyloxy-pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis (2,4-di-tert-butylphenyl) 4,4′-biphenylene-diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl)methyl phosphite and bis(2,4-di-tert-butyl-6-methylphenyl)ethyl phosphite.

11. A composition according to claim 1 where the organic phosphorus stabilizers are selected from the group consisting of tris(2,4-di-tert-butylphenyl)phosphite, tris(nonylphenyl)phosphite,

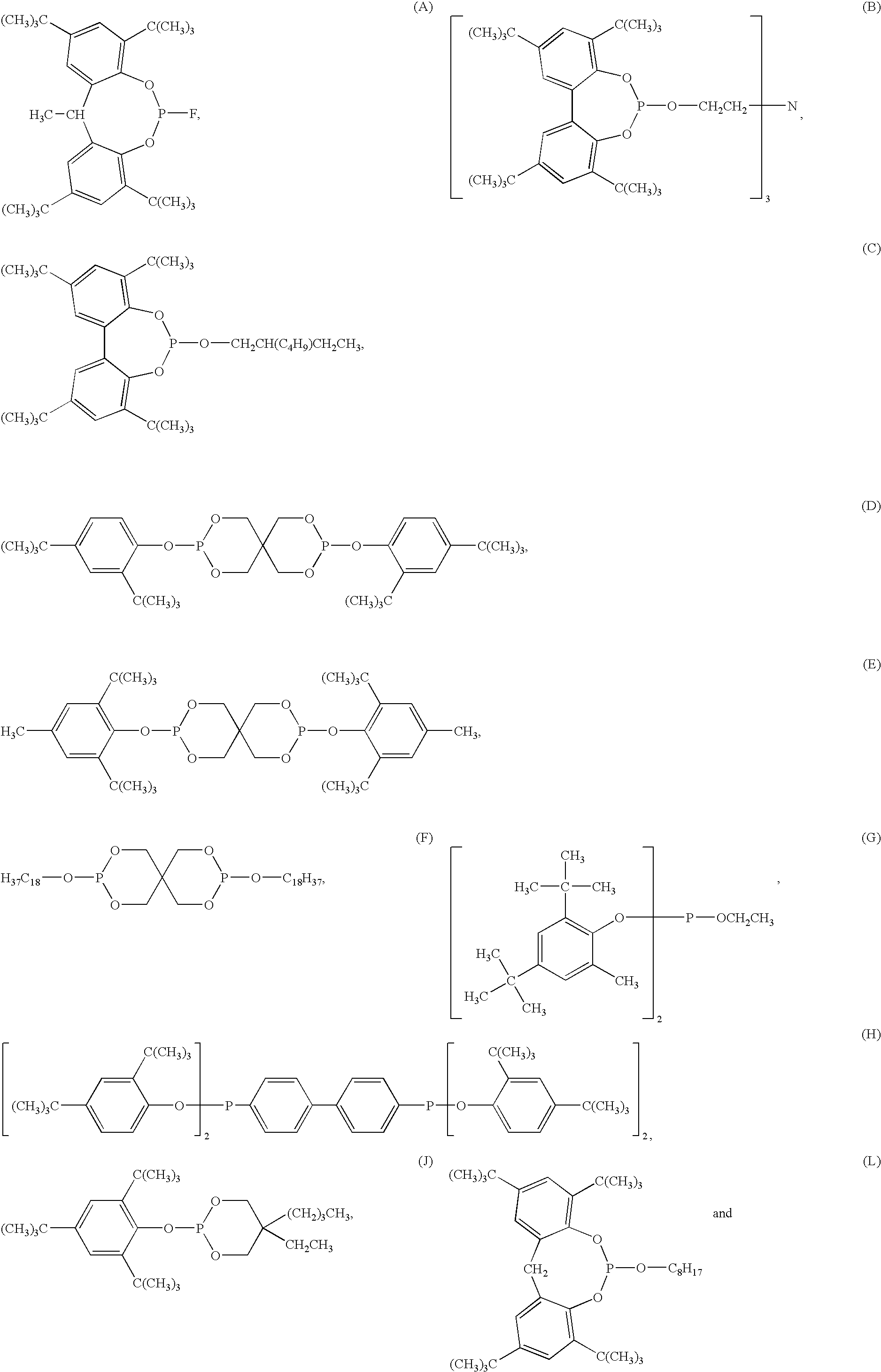

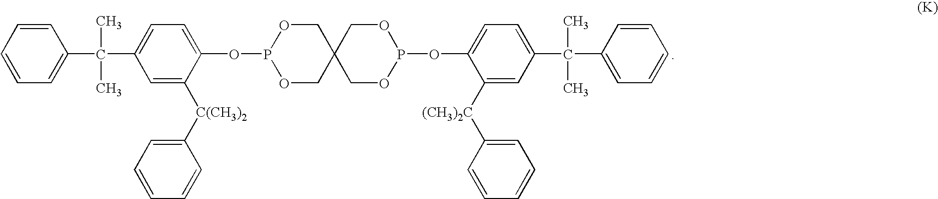

12. A composition according to claim 1 where the organic phosphorus stabilizers are selected form the group consisting of tris(2,4-di-tert-butylphenyl) phosphite, bis(2,4-di-tert-butyl-6-methylphenyl)ethyl phosphite, bis(2,4-di-tert-butylphenyl)pentaerythritol diphosphite, tetrakis(2,4-di-tert-butylphenyl)4,4′-biphenylene-diphosphonite, 2,2′,2″-nitrilo[triethyltris-(3,3′,5,5′-tetra-tert-butyl-1,1′-biphenyl-2,2′-diyl)phosphite],

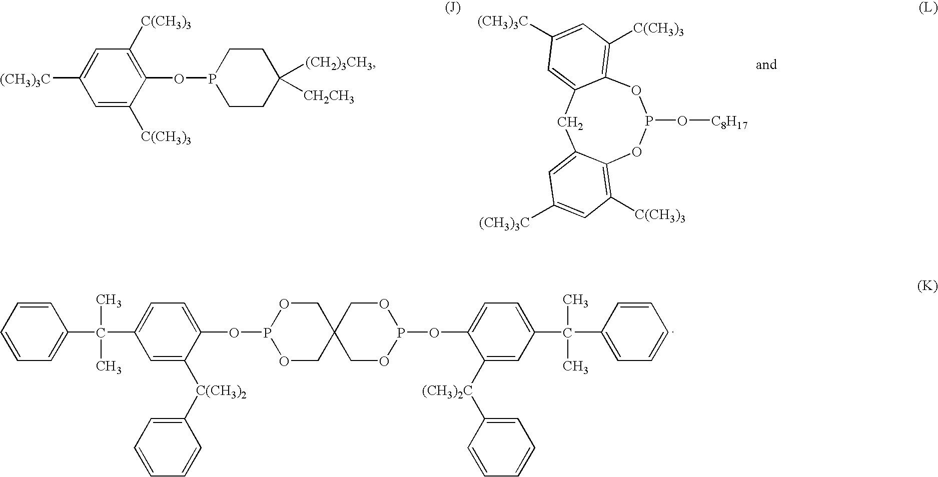

13. A composition according to claim 1 where the stabilizers, in total, are present from about 50 ppm to about 3 pph, by weight, based on the weight of the iodonium salt photoinitiator.

14. A composition according to claim 1 where the stabilizers, in total, are present from about 100 ppm to about 2 pph, based on the weight of the iodonium salt photoinitiator.

15. A composition according to claim 1 where the stabilizers, in total, are present from about 250 ppm to about 1 pph, based on weight of the iodonium salt phtoinitiator.

16. A composition according to claim 1 where the cationically polymerizable compounds are selected from the group consisting of cycloaliphatic epoxy compounds, glycidyl ethers, oxetane compounds, vinyl ethers, acid-crosslinkable melamine resins, acid-crosslinkable hydroxymethylene compounds and acid-crosslinkable alkoxy-methylene compounds.

17. A method for curing a cationically polymerizable composition, which method comprises applying a compositon comprising
at least one cationically polymerizable compound,
at least one iodonium salt photoinitiator and
an effective stabilizing amount of at least one compound selected from the group
consisting of organic phosphorus stabilizers to a substrate and
exposing the composition for a suitable time to ultraviolet radiation.

18. A method according to claim 17 for the preparation of surface coating compositions, powder coating compositions, printing inks, printing plates, dental compounds, stereolithography resins, adhesives, anti-adhesive coatings, color filters, resist materials or image-recording materials.

19. A cationic photoinitiator composition comprising
at least one iodonium salt photoinitiator and
an effective stabilizing amount of at least one compound selected from the group
consisting of organic phosphorus stabilizers.
